(19) United States
(12) Patent Application Publication
(10) Pub. No.: US 2025/0134117 A1
(43) Pub. Date: May 1, 2025

(54) MULTI-LAYERED FOOD PRODUCT AND METHOD FOR FORMING

(71) Applicant: Arlington Valley Farms LLC, Hudson, OH (US)

(72) Inventor: Peter Jacobson, Cleveland, OH (US)

(21) Appl. No.: 18/940,418

(22) Filed: Nov. 7, 2024

Related U.S. Application Data
(63) Continuation of application No. 18/386,736, filed on Nov. 3, 2023.
Application No. 18/386,736 is a continuation of application No. 17/533,975, filed on Nov. 23, 2021, now Pat. No. 11,910,799.
Application No. 17/533,975 is a continuation of application No. 16/708,644, filed on Dec. 10, 2019, now abandoned.
Application No. 16/708,644 is a continuation-in-part of application No. 15/296,088, filed on Oct. 18, 2016, now Pat. No. 10,537,111.
Application No. 15/296,088 is a division of application No. 13/419,505, filed on Mar. 14, 2012, now Pat. No. 10,448,653.
Application No. 13/419,505 is a continuation-in-part of application No. 12/958,313, filed on Dec. 1, 2010, now Pat. No. 10,457,804.
(60) Provisional application No. 61/265,457, filed on Dec. 1, 2009.
(60) Provisional application No. 63/547,636, filed on Nov. 7, 2023.

(51) Int. Cl. A21D 13/31; A21D 8/06; A21D 13/14; A21D 13/22; A21D 13/24; A21D 13/32

(52) U.S. Cl. CPC A21D 13/31; A21D 8/06; A21D 13/14; A21D 13/22; A21D 13/24; A21D 13/32

(57) ABSTRACT

A multi-layered food product comprises a filling encapsulated by a dough layer, and the multi-layered food product can optionally include one or more toppings atop the dough layer.

### RELATED APPLICATIONS

This application is a continuation of U.S. patent application Ser. No. 18/386,736 file Nov. 3, 2023, which in turn is a continuation of U.S. patent application Ser. No. 17/533,975 filed Nov. 23, 2021 (now U.S. Pat. No. 11,910,799), which in turn is a continuation of U.S. patent application Ser. No. 16/708,644 filed Dec. 10, 2019 (now abandoned), which in turn is a continuation-in-part of U.S. patent application Ser. No. 15/296,088 filed Oct. 18, 2016 (now U.S. Pat. No. 10,537,111), which in turn is a divisional of U.S. patent application Ser. No. 13/419,505 filed Mar. 14, 2012 (now U.S. Pat. No. 10,448,653), which is a continuation-in-Part of U.S. patent application Ser. No. 12/958,313 filed Dec. 1, 2010 (U.S. Pat. No. 10,457,804), which claims priority from U.S. Provisional Application Ser. No. 61/265,457 filed Dec. 1, 2009 (now abandoned), wherein the entirety of each of the aforementioned applications is hereby incorporated by reference.

This application also claims priority on U.S. Provisional Application Ser. No. 63/547,636 filed Nov. 7, 2023, wherein the entirety of the aforementioned application is hereby incorporated by reference.

### TECHNICAL FIELD

The disclosure relates generally to filled food products, particularly to a multi-layered food product and method for forming the multi-layered food product, more particularly to a multi-layered food product that includes a filling, a dough layer about the filling, and optionally one or more toppings on the top and/or bottom surface of the dough layer and method for making the same.

### BACKGROUND OF THE DISCLOSURE

Demand for convenience food has steadily increased in recent years. As people look to find ways to maximize free time, ready-made meals and snack products have become increasingly popular with consumers. Most households now have a microwave oven to assist in the rapid heating of food. Accordingly, a large number of ready-made meals and snacks have been developed which can be heated in a microwave oven.

While these types of snacks and meals can be quickly heated in a microwave oven, the types of meals and snacks that are suitable for heating in such ovens are, to some extent, limited. For example, snacks of a type which have a filling surrounded by a crispy coating typically cannot be satisfactorily prepared in a microwave oven. This is because steam, generated during the heating process by evaporation of water from the filling, is deleterious to organoleptic qualities of the coating. Steam penetrates the outer coating rendering it moist, soggy, and unappetizing. Such crispy-coated products are typically best prepared by heating in a conventional oven or frying in oil to maintain crispness. This considerably lengthens the time required to prepare such snacks, thus making them far less convenient to prepare, and additionally frying lessens the nutritional value of the product. The present disclosure is directed to a food product that is configured to utilize the microwave for quick preparation while also pairing with a conventional toaster, or toaster oven or air fryer to leverage the best qualities of a light and airy baked ready to cat filled meal with the crispy crust qualities desired by today's consumers. Further, present disclosure is directed to a food product that deploys an exponentially faster food manufacturing process which dramatically increases production throughput, strengthening the American food supply through this efficiency.

### SUMMARY OF THE DISCLOSURE

According to one non-limiting aspect of the disclosure, there is provided a multi-layered food product that includes a filling, a dough layer about the filling, and method for forming the multi-layered food product. The dough layer is formed about the filling to substantially encapsulate the filling or fully encapsulate the filling. The composition of the filling is different from the composition of the dough layer. In one non-limiting embodiment, the dough layer is a yeast-containing dough layer. As defined herein, a dough layer can include both traditional dough materials and highly viscous batter materials. The dough layer can include yeast and/or chemical leavening agents. For purposes of this disclosure, the filling is considered a layer of the multi-layered food product. As such, a single layer of dough that partially or fully encapsulates the filling forms a multi-layered food product in accordance with the present disclosure.

According to another non-limiting aspect of the disclosure, there is provided a multi-layered food product that includes a filling, a dough layer about the filling, and method for forming the multi-layered food product. The dough layer is formed about the filling to substantially encapsulate the filling (e.g., 70-99.99% encapsulated and all values and ranges therebetween) or fully encapsulate the filling. The composition of the filling is different from the composition of the dough layer. In one non-limiting embodiment, the dough layer is a a) a yeast-containing dough layer, b) a baking soda containing dough layer, c) a combination of both a yeast-containing and baking soda containing dough layer, or d) a dough layer without yeast or chemical leavening.

According to another non-limiting aspect of the disclosure, the one or more toppings can optionally be applied to one or more portions of the top, side, and/or bottom surfaces of the outer surface of the dough layer. In one non-limiting embodiment, at least 25% of the top, side, and/or bottom surfaces of the outer surface of the dough layer includes one or more toppings (e.g., 25-100% and all values and ranges therebetween). In one non-limiting embodiment, at least 50% of the top, side, and/or bottom surfaces of the outer surface of the dough layer includes one or more toppings. The one or more toppings are generally applied to the top, side and/or bottom surfaces of the outer surfaces of the dough layer prior to the dough layer being fully baked. In one non-limiting embodiment, the one or more toppings are partially or fully applied (e.g., 1-100% of the one or more toppings applied and all values and ranges therebetween) to the top, side and/or bottom surfaces of the outer surface of the dough layer prior to the dough layer being baked. In another non-limiting embodiment, the one or more toppings are partially or fully applied (e.g., 1-100% of the one or more toppings applied and all values and ranges therebetween) to the top, side and/or bottom surfaces of the outer surface of the dough layer prior to the dough layer being partially or fully proofed. In another non-limiting embodiment, the one or more toppings are partially or fully applied (e.g., 1-100% of the one or more toppings applied and all values and ranges therebetween) to the top, side and/or bottom surface of the outer surface of the dough layer after the dough layer has been proofed and prior to the dough layer being baked. In another non-limiting embodiment, the one or more toppings are partially or fully applied (e.g., 1-100% of the one or more toppings applied and all values and ranges therebetween) to the top, side, and/or bottom surface of the outer surface of the dough layer prior to, during, and/or after the dough layer being par baked (e.g., dough layer baked 5-97% of fully being baked and all values and ranges therebetween) and prior to the dough layer being fully baked.

According to another non-limiting aspect of the disclosure, one or more ingredients can optionally be mixed into the dough layer during mixing at a percentage typically between 0.5-95% (and all values and ranges therebetween). In one non-limiting embodiment, one or more ingredients can be added to and/or mixed with the dough a) before the dough is used to substantially or fully encapsulate the filling layer, or b) prior to optionally proofing and then baking the multi-layer food product.

According to another non-limiting aspect of the disclosure, the filling that can be used in the multi-layered food product is non-limiting. Non-limiting examples of fillings include meat-based fillings (e.g., hamburger-based filings, steak-based fillings, beef-based fillings, buffalo-based fillings, goat-based fillings, lamb-based filings, sausage-based fillings, bacon-based fillings, ham-based fillings, turkey-based fillings, game-based fillings, fowl-based fillings, chicken-based fillings, pork-based fillings, pepperoni-based fillings, deli meat-based fillings, pâté, etc.), seafood-based fillings (e.g., fish-based fillings, shrimp-based fillings, scallop-based filings, mussel-based fillings, clam-based fillings, crab-based fillings, etc.), sauces (e.g., tomato-based sauce, alfredo sauce, meat sauce, pesto sauce, gravy, barbecue, etc.), stews, chili, casseroles, egg-based filling (e.g., scrambled egg filling, scrambled egg and bacon, ham, and/or sausage filling, scrambled eggs and cheese, scrambled eggs, cheese and meats, such as bacon, ham or sausage, etc.), fruit-based fillings (e.g., apple fillings, cherry fillings, berry fillings, banana fillings, etc.), dairy-based and/or non-dairy based filings (e.g., cream fillings, whipped cream fillings, cheese fillings, ham and cheese, sausage and cheese, yogurt fillings, butter fillings, etc.), caramel fillings, jelly-based filling, jam-based filling, syrup-based filling, eggnog-based filling; butterscotch fillings, processed cereal-based fillings, oat-based fillings, grain-based fillings, rice-based fillings, hummus-based fillings, beans, lentils, plant based filling, candy- or confectionary-based fillings, gelatin fillings, pudding fillings, custard fillings, chocolate fillings, fudge fillings, marshmallow fillings, nut-based fillings, vegetable-based fillings (e.g., arrowroot, artichoke, arugula, asparagus, bamboo shoots, beans, beets, broccoli, brussels sprouts, cabbage, carrot, cauliflower, celery, collards, corn, cucumber, soybeans, eggplant, ginger root, horseradish, kale, leeks, lettuce, mushrooms, mustard greens, okra, onion, peas, peppers, potato, pumpkin, radishes, rutabaga, shallots, squash, sweet potato, tomato, turnip, watercress, yam root, zucchini, etc.), gravy, nuts (e.g., peanuts, pistachios, walnuts, almonds, cashews, pecans, pine nuts, etc.), seeds (e.g., sesame seeds, pumpkin seeds, poppy seeds, sunflower seeds, flax seeds, wheat germ, etc.), butter, nut butter, peanut butter, confectionary, and/or a combination thereof. The filling in the multi-layered food product generally constitutes about 2-90 wt. % (and all values and ranges therebetween) of the multi-layered food product, and typically about 15-60 wt. % of the multi-layered food product. It can be appreciated that any of the above listed fillings can be used as a topping on the multi-layered food product.

According to another non-limiting aspect of the disclosure, the dough layer partially or fully encapsulates the filling. In one non-limiting embodiment, the dough layer encapsulates at least 70 vol. % of the filling (e.g., 70-100 vol. % and all values and ranges therebetween), typically the dough layer encapsulates at least 90 vol. % of the filling, and more typically the dough layer encapsulates at least 95 vol. % of the filling. In one non-limiting configuration, the dough layer encapsulates 100 vol. % of the filling. The dough layer is formulated to both shape the filling in the cavity of the dough layer and to give the multi-layered food product structure so that the multi-layered food product can be eaten by the hand of a user without falling apart. As such, the dough layer is formulated for elasticity and structure (e.g., gluten structure) to stretch uniformly around the filling, shape the filling, and provide a supportive structure to the multi-layered food product structure so that the multi-layered food product can be eaten by the hand of a user without falling apart.

According to another non-limiting aspect of the disclosure, the dough layer, prior to baking, includes flour (e.g., gluten flours [e.g., wheat flour, barley flour, rye flour, etc.] and/or non-gluten flours [e.g., potato flour, rice flour, corn flour, almond flour, buckwheat flour, sorghum flour, amaranth flour, teff flour, arrowroot flour, oat flour, chickpea flour, coconut flour, tapioca flour, cassava flour, tigernut flour, millet flour, navy bean flour, quinoa flour, peanut flour, etc.], water-containing component (e.g., water, egg, milk, butterfat milk, buttermilk, and/or non-dairy milk [e.g., coconut milk, almond or other type of nut milk, soy milk, rice milk, hemp milk, etc.], etc.), and leavening agent (e.g., yeast, chemical-leavening agent, baking soda, baking powder, whole eggs, egg whites, etc.). The dough layer can optionally include flavorings and/or spices (e.g., butter flavor, almond extract, vanilla extract, maple, blueberry, natural or artificial flavor, cinnamon, nutmeg, etc.), salt, milk powder, gluten (a gluten source other than gluten flour [e.g., vital wheat gluten, etc.]), sweetener (e.g., sugar, sucrose, fructose, honey, corn syrup, HFCS, artificial sweetener, etc.), shortening (e.g., butter, margarine, vegetable oil, peanut oil, lard, corn oil, coconut oil, sunflower oil, soybean oil, olive oil, palm oil, canola oil, etc.), and/or eggs. In one non-limiting embodiment, the dough layer, prior to being baked, includes 25-90 wt. % flour (and all values and ranges therebetween), 20-60 wt. % water-containing component (and all values and ranges therebetween), and 0.2-10 wt. % leavening agent (and all values and ranges therebetween). In another non-limiting embodiment, the dough layer, prior to being baked, includes 25-90 wt. % flour (and all values and ranges therebetween), 20-85 wt. % water containing component (and all values and ranges therebetween), 0.2-10 wt. % leavening agent (and all values and ranges therebetween), 0-10 wt. % milk powder (and all values and ranges therebetween), 0-50 wt. % eggs (and all values and ranges therebetween), 0-9 wt. % gluten (and all values and ranges therebetween), 2-50 wt. % sweetener (and all values and ranges therebetween), 0-30 wt. % shortening (and all values and ranges therebetween), 0-5 wt. % salt (and all values and ranges therebetween), and 0-5 wt. % flavoring agent (and all values and ranges therebetween). In another non-limiting embodiment, the dough layer, prior to being baked, includes 27-68 wt. % flour, 21-57 wt. % water, 0-9 wt. % milk powder, 2-15 wt. % eggs, 2-5 wt. % gluten, 2-15 wt. % sugar, 0-15 wt. % oil, 0.5-15 wt. % yeast, 0.5-2 wt. % salt, and 0-3 wt. % flavoring agent. In another non-limiting embodiment, the dough layer, prior to being baked, includes 45-60 wt. % flour, 21-30 wt. % water, 0)-7 wt. % milk powder, 5-12 wt. % eggs, 0-4 wt. % gluten, 2-12 wt. % sugar, 0-12 wt. % oil, 0.5-8 wt. % yeast, 0.5-2 wt. % salt, 0-2 wt. % flavoring agent. In another non-limiting embodiment, the dough layer, prior to being baked, includes 30-69 wt. % flour, 20-40 wt. % water-containing component (and all values and ranges therebetween), 0.2-6 wt. % leavening agent (and all values and ranges therebetween) wherein 60-100% of the leavening agent is chemically-leavening agent, 0-9 wt. % milk powder (and all values and ranges therebetween), 0-40 wt. % eggs (and all values and ranges therebetween), 0-8 wt. % gluten (and all values and ranges therebetween), 2-30 wt. % sweetener (and all values and ranges therebetween), 0-16 wt. % shortening (and all values and ranges therebetween), 0-3 wt. % salt (and all values and ranges therebetween), and 0-4 wt. % flavoring agent (and all values and ranges therebetween). In another non-limiting embodiment, the dough layer includes yeast. The yeast can constitute 0-100% (and all values and ranges therebetween) of the leavening agent in the dough layer, and typically constitutes 80-100% of the leavening agent in the dough layer. In another non-limiting embodiment, the dough layer is absent yeast. In another non-limiting embodiment, the dough layer includes eggs. The eggs facilitate in creating structure and stability within the dough layer, facilitate in thickening the dough layer, add moisture to the dough layer, and/or facilitate in the rising of the dough layer during the proofing and baking of the dough layer. In another non-limiting embodiment, the dough layer includes gluten. The gluten is used to facilitate in providing structure to the dough layer. The gluten can be added as a separate component and/or a gluten-containing flour can be used to supply the gluten to the dough layer. Generally, the gluten content of the dough layer is 1-18 wt. % gluten (and all values and ranges therebetween), and typically 5-12 wt. % gluten. The dough used to form the dough layer generally has a viscosity of about 100,000-1,500,000 cps at 21° C. As such, the dough cannot be poured about the filling at 21° C., thus must be formed about the filling. The forming of the dough layer about the filling can be by hand and/or by use of a machine. In one non-limiting method, a portion of the pre-mixed dough is selected and a cavity is depressed or otherwise formed in the dough portion. Thereafter, a filling is placed in the cavity and the outer edges of the dough pushed together to partially or fully close the cavity so as to partially or fully encapsulate the filling in the cavity of the dough, and/or another piece of dough can be placed over the filling in the cavity to partially or fully encapsulate the filling in the cavity of the dough. The dough layer in the multi-layered food product generally constitutes about 8-92 wt. % (and all values and ranges therebetween) of the multi-layered food product, and typically about 40-70 wt. % of the multi-layered food product.

According to another non-limiting aspect of the disclosure, the dough layer, as described above, is leavened by a combination of both yeast and chemical leavening, such as baking powder or baking soda. In this embodiment the yeast or chemical leavening can represent between 2% and 98% of the dough leavening and all values in between.

According to another non-limiting aspect of the disclosure, the dough layer, as described above, is leavened solely by chemical leavening, such as baking powder and or baking soda. In this non-limiting embodiment, the chemical leavening represents up to 100% of the leavening in the dough layer.

According to another non-limiting aspect of the disclosure, the dough layer, as described above, contains no yeast or chemical leavening.

According to another non-limiting aspect of the disclosure, the dough layer, as described above, contains no gluten.

According to another non-limiting aspect of the disclosure, the thickness of the dough layer and the topping(s) layer after the multi-layered food product has been fully baked are typically different. In one non-limiting embodiment, the total thickness of the one or more toppings is 0.01-0.5 in. (and all values and ranges therebetween). In another non-limiting embodiment, the total thickness of the one or more toppings is 0.025-0.4 in. Generally, the total thickness of the one or more toppings constitutes 2-500% of the thickness of the dough layer (and all values and ranges therebetween) after multi-layered food product has been fully baked. In one non-limiting configuration, the total thickness of the one or more toppings constitutes 5-200% of the thickness of the dough layer after multi-layered food product has been fully baked.

According to another non-limiting aspect of the disclosure, the one or more toppings that can be applied to the top surface of the dough layer can include one or more dairy ingredients (e.g., shredded cheese [e.g., cheddar, swiss, mozzarella, habanero, parmesan, etc.], cheese powders [e.g., cheddar, butter, nacho, sour cream & onion, parmesan, blue cheese etc.]), eggs (scrambled or otherwise), meats of any kind, artificial dairy ingredients (e.g., artificial cheese and/or cheese powders, etc.), vegetables (e.g., broccoli, asparagus, chives, onions, corn, peppers, spinach, broccoli, etc.), tomatoes, sun-dried tomatoes, mushrooms, olives, herbs (e.g., rosemary, thyme, basil, red pepper, parsley, etc.), toasted crumbs (e.g., corn bread, croutons, panko, etc.), seasonings (e.g., barbecue, tomato sauce, pasta sauce, nacho, jalapeno, hot peppers, garlic, chili powder, cumin, cayenne pepper, red pepper, salt, pepper, pizza flavor, cinnamon, nutmeg, etc.), sugars (e.g., cane, beet, cinnamon sugar, sugar sprinkles, various confectionary products, syrup, etc.), corn meal, semolina, farina, caramel, chocolate and/or chocolate powder, butterscotch, butter, nut butter, nuts (e.g., peanuts, pistachios, walnuts, almonds, cashews, pecans, pine nuts, etc.), seeds (e.g., sesame seeds, pumpkin seeds, poppy seeds, sunflower seeds, flax seeds, wheat germ, etc.), and/or clusters (e.g., oat, granola, wheat, cheese, savory and sweet clusters, nut, sweet streusel, etc.). The one or more toppings that can be applied to the top surface of the dough layer are formulated to fully bond with the dough layer when the multi-layered food product is fully baked. The one or more toppings are used to 1) provide improved taste, 2) provide more impactful flavor, 3) create an improved appearance, 4) create an artisan appearance, 5) create a crafted appearance, 6) create a homemade appearance to the multi-layered food product when the multi-layered food product is fully baked, and/or 7) provide improved nutrition.

According to another non-limiting aspect of the disclosure, the one or more ingredients (inclusions) that can be mixed within the dough layer can include one or more dairy ingredients (e.g., shredded cheese [e.g., cheddar, swiss, mozzarella, habanero, parmesan, etc.], cheese powders [e.g., cheddar, butter, nacho, sour cream & onion, parmesan, blue cheese etc.]), artificial dairy ingredients (e.g., artificial cheese and/or cheese powders, etc.), eggs (scrambled or other), meats of any kind, vegetables (e.g., broccoli, asparagus, chives, onions, corn, peppers, spinach, broccoli, etc.), tomatoes, sun-dried tomatoes, mushrooms, olives, herbs (e.g., rosemary, thyme, basil, red pepper, parsley, etc.), toasted crumbs (e.g., corn bread, croutons, panko, etc.), seasonings (e.g., barbecue, tomato sauce, pasta sauce, nacho, jalapeno, hot peppers, garlic, chili powder, cumin, cayenne pepper, red pepper, salt, pepper, pizza flavor, cinnamon, nutmeg, etc.), sugars (e.g., cane, beet, cinnamon sugar, sugar sprinkles, various confectionary products, syrup, etc.), corn meal, semolina, farina, caramel, chocolate and/or chocolate powder, butterscotch, butter, nut butter, nuts (e.g., peanuts, pistachios, walnuts, almonds, cashews, pecans, pine nuts, etc.), seeds (e.g., sesame seeds, pumpkin seeds, poppy seeds, sunflower seeds, flax seeds, wheat germ, etc.), and/or clusters (e.g., oat, granola, wheat, cheese, savory and sweet clusters, nut, sweet streusel, etc.). The one or more ingredients that can be mixed within the dough layer are formulated to fully bond with the dough layer when the multi-layered food product is fully baked. The one or more toppings are used to 1) provide improved taste, 2) provide more impactful flavor, 3) create an improved appearance, 4) create an artisan appearance, 5) create a crafted appearance, 6) create a homemade appearance to the multi-layered food product when the multi-layered food product is fully baked, and/or 7) provide improved nutrition.

According to another non-limiting aspect of the disclosure, the one or more ingredients that can be mixed within the dough layer are mixed into the dough layer during dough mixing at a percentage typically between 5-50% before the dough is used to substantially or fully encapsulate the filling layer prior to optionally proofing and then baking the multi-layer food product.

According to another non-limiting aspect of the disclosure, the one or more toppings that can be applied to the top surface of the dough layer generally constitutes about 0.5-50 wt. % (and all values and ranges therebetween) of the fully baked multi-layered food product. In one non-limiting embodiment, the one or more toppings in the multi-layered food product generally constitute about 1-15 wt. % of the fully baked multi-layered food product. In another non-limiting embodiment, the one or more toppings in the multi-layered food product generally constitute about 3-7 wt. % of the fully baked multi-layered food product. In another non-limiting embodiment, the one or more toppings on the multi layered food product constitute 15-50 wt. % of the fully baked food product.

According to another non-limiting aspect of the disclosure, the one or more toppings that can be applied to the top surface of the dough layer are formulated to partially (at least 20% caramelization of the topping) or fully caramelize when the multi-layered food product is fully baked, which further improves the taste, flavor, and appearance of the multi-layered food product, and which partial or full caramelization enhances the bonding of the partially or fully caramelized topping to the dough layer.

According to another non-limiting aspect of the disclosure, there is provided a fully-closed cavity baking container or vessel, intermittently open-topped cavity baking container or vessel, or open-topped cavity baking container or vessel that is used to partially or fully bake the multi-layered food product. The shape of the closed-cavity, intermittently open-topped cavity baking container or vessel, or open topped baking container is non-limiting (e.g., puck-shaped, cylindrical-shaped, waffle-shaped, disc- or saucer-shaped, square, etc.). The closed-cavity or open topped baking container or vessel can optionally be used to cause a portion of the inner surface of the cavity to press the one or more toppings partially or fully into the dough layer, thereby facilitating in the securing of the one or more toppings to the dough layer; however, this is not required. The closed-cavity baking container, when used, can also optionally create an elevated pressure from the production of gasses and/or steam during the baking of the multi-layered food product, which elevated pressure facilitates in causing the partial or full bonding of the one or more toppings to the dough layer. The pressure and steam that is created in the closed topped-cavity baking container or vessel optionally further ensures that the one or more toppings are completely and seamlessly bonded to the dough layer. Such pressure in the closed topped-cavity baking container or vessel during the baking of the multi-layered food product is at least 0.1 Atm. above ambient pressure or sea level pressure, and typically 0.1-5 Atm. (and all values and ranges therebetween) above ambient pressure or sea level pressure. During the baking of the multi-layered food product. In one non-limiting embodiment, the multi-layered food product is a) fully baked in the oven in a closed topped-cavity, b) fully baked in the oven in an open topped-cavity, c) partially baked in a closed topped-cavity (baked 1-99% and all values and ranges therebetween in a closed topped-cavity) and partially baked in an open topped-cavity (baked 1-99% and all values and ranges therebetween in an open topped-cavity), d) fully or partially baked in a closed and intermittently open baking cavity.

The baking time in the closed, intermittently open-topped cavity baking container or vessel, or open topped-cavity baking container or vessel is generally at least 0.5 minutes, and typically 1-28 minutes (and all values and ranges therebetween) at a temperature of 180-550° F. (and all values and ranges therebetween). Generally, the baking of the multi-layered food product in the closed, intermittently open-topped cavity baking container or vessel, or open topped-cavity baking container or vessel is by non-microwave cooking (e.g., convection heating, conduction heating).

According to another non-limiting aspect of the disclosure, after the one or more toppings are added to the top, side and/or bottom surface of the dough layer, a butter or oil spray or non-stick spray optionally can be applied to the one or more toppings to 1) inhibit or prevent sticking of the one or more toppings to a baking surface, and/or to inhibit or prevent the multi-layered food product from sticking to the baking cavity or vessel so that it can be easily removed after baking and/or 2) further improve the appearance of the one or more toppings on the multi-layered food product through increased caramelization of the one or more toppings after the multi-layered food product has been partially or fully baked and/or 3) further improve the taste of the multi-layered food product.

According to another non-limiting aspect of the disclosure, there is provided a method for forming a multi-layered food product. The method includes a) providing a filling, b) providing a dough layer, c) partially or fully encapsulating the filling in the dough layer, and d) partially or fully baking the dough layer. The method can optionally include the step of adding one or more toppings to the outer surface of the dough layer. The dough layer is partially or fully baked to allow the dough layer to set and render it be safe for consumption. The method can optionally include providing one or more toppings on the top, side and/or bottom of the dough layer. Generally, the dough layer encapsulates about 70-100% of the filling (and all values and ranges therebetween). The dough layer is baked for a time period such that the dough layer is 50-100% baked (and all values and ranges therebetween), and typically the dough layer is baked for a time period such that the dough layer is 75-100% baked. The method can optionally further include the step of partially or fully proofing the dough layer prior to the partial or full baking of the dough layer. Generally, the dough layer, when optionally proofed, is allowed to proof for a time period to enable the dough to be 50-100% proofed (and all values and ranges therebetween), and typically is allowed to proof for a time period to enable the dough to be 80-100% proofed. The method can optionally further include the step of shaping the dough layer after the dough layer has partially or fully encapsulated the filling and prior to the partial or full baking of the dough layer. In one non-limiting embodiment, the dough layer that includes the filling can be shaped into a generally puck-shape; however, it can be appreciated that the dough layer can be shaped into other shapes (e.g., rectangular, circular, ovoid, square, triangular, cylindrical, star-shaped, waffle-shaped, pocketed waffle-shaped, or any other polygonal shape). During the shaping of the dough layer, the top of the dough layer can be pressed downwardly such that the top and bottom portions of the dough layer that includes the fillings are partially flattened. Generally, the average height to maximum width ratio of the optionally shaped dough layer is generally at least 1:1.5 (e.g., 1:1.5 to 1:10 and all values and ranges therebetween), typically 1:2, move typically 1:3, and even more typically 1:4. The optional shaping of the dough layer can be by hand and/or by a machine. The method can optionally include the step of partially or fully baking the dough layer in a bi-molded plate assembly that has a central cavity that can form a closed enclosure during the baking of the multi-layered food product. In one non-limiting arrangement, one or both of the plates of the bi-molded plate assembly include a recessed region that is configured to partially or fully receive the multi-layered food product and partially or fully form the central cavity when the two plates are positioned together. During the baking process, when a bi-molded plate assembly is used, the multi-layered food product is a) fully baked in the closed central cavity while the multi-layered food product is positioned in the oven, or b) only partially baked in the closed central cavity while the multi-layered food product is positioned in the oven for a portion of time of baking in the oven and the two plates are partially separated from one another so that the multi-layered food product is positioned in an open cavity when positioned in the oven for a portion of time of baking in the oven. The shape of the cavity of one or both of the two plates is non-limiting (e.g., puck-shaped, cylindrical-shaped, waffle-shaped, disc- or saucer-shaped, star-shaped, cube-shaped, box-shaped, etc.). It should be further appreciated that the recessed baking cavity of any shape can have a surface pattern (e.g., waffle pattern, etc.) that will provide a pattern or unique shape to the finish baked multi-layered food product. It should also be appreciated that the baking cavity with a pattern can have an additional cavity or spacing within the cavity (top and bottom or only top or only bottom) to protect the integrity of the filling (layer), when used, from being disturbed, damaged, leaked, or spilled out of the dough layer during the baking process when the baking cavity is closed. An example of this would be a baking cavity that has a waffle grid pattern in the top and or the bottom baking cavity. Such waffle grid could optionally have an internal cavity or pocket inside the waffle pattern that provides additional spacing (e.g., one or more recessed regions on one or both plates of the baking cavity, etc.) when the baking cavity is closed so to protect the integrity of the filling inside the dough layer of the multi-layered food product during baking. In one non-limiting embodiment, the top and/or bottom plates include one or more recessed portions that form one or more the pockets within the baking cavity when the baking cavity is closed, and wherein the one or more pockets can constitute 1-95% (and all values and ranges therebetween) of the top baking cavity area and/or 1-95% (and all values and ranges therebetween) of the bottom baking cavity area.

According to another aspect of the present disclosure, the pocket within the surface pattern of the baking cavity (e.g. waffle grid with pocket within the grid, etc.) can be used to a) protect the filling integrity from being damaged and spilling onto the baking cavity and (e.g. waffle grid, etc.), b) improves the appearance of the filling layer so it doesn't push into or fully through the dough layer (e.g., still looks like a waffle), and/or c) inhibits or prevent the filling from spilling and burning on the baking cavity, thereby causing the multi-layered food product to stick to the baking cavity and thus impairing or preventing the multi-layered food product from being removed from the baking cavity when finished baking.

According to another non-limiting aspect of the present disclosure, the edges of the patterned surface area within the baking cavity (e.g. waffle teeth surface) can be rounded or softened so that they are not sharp and will prevent or limit the amount of damage to the multi-layered food product or the filling layer of the multi-layered food product.

According to another non-limiting aspect of the present disclosure, the surface pattern need not be within a cavity, but can simply represent the entire baking surface, top and bottom surface, or only top surface or only bottom surface, and said patterned baking surface (e.g., waffle grid baking surface, etc.) representing the plate surface can have a pocket within its surface as described above with a depth of 1-95% (and all values and ranges therebetween) in between of the surface grid pattern (e.g., waffle grid, etc.) to protect the integrity of the filling (layer) from being disturbed, damaged, leaked, or spilled out of the filling layer during the baking process when the top and bottom bi-molded plates are closed. The pocket upon the open grid patterned plate can be used to a) protect the filling integrity from being damaged and spilling onto the baking plate and (e.g. waffle grid), b) improve the appearance of the filling layer so it doesn't push into the dough layer, and so it can appear as a normal waffle or other baked product, but with a hidden filling, and c) prevent the filling from spilling and burning onto the open surface pattern (e.g. waffle grid) causing the multi-layered food product to stick to the baking surface preventing the finish baked multi-layered food product from being removed when finished baking.

According to another non-limiting aspect of the present disclosure, during the baking time that the dough layer of the multi-layered food product is positioned in a heated closed cavity or heated closed pocketed surface baking plate (e.g., waffle grid surface with pocket, etc.), the closed cavity/plate at least partially entraps steam and/or other gasses generated during the baking of the dough layer and the heating of the filling, thereby causing a pressure increase in the central cavity or surface pocket during the partial or full baking of the dough layer of the multi-layered food product. Such pressure increase in the central cavity can 1) facilitate in the baking of the dough layer, and/or 2) facilitate in the bonding of the one or more toppings optionally on the surface of the dough layer. Also, the closed central cavity can result in a portion of the inner surface of the closed central cavity pressing the one or more toppings partially or fully into the dough layer, thereby facilitating in the securing of the one or toppings to the dough layer; however, this is not required. The heat and pressure created from the heated closed baking cavity during baking can speed up the bake time of the multi-layered food product and/or can ensure that the multi-layered food product's filling reaches a hot enough safe temperature to produce a “kill step” which ensures that any dangerous pathogens are eliminated during the baking process. The heat and pressure also allows the multi-layered food product to be consumed under the USDA “Heat-Treated or “Ready-to-Eat” guidelines. The rapid increase in heat and steam pressure created by the heated closed baking cavity dramatically decreases the bake time of the multi-layered food product as well as dramatically increasing the speed (e.g., dramatically reduces the time) that the multi-layered food product reaches a USDA kill step to facilitate in ensuring the destruction of any food borne pathogens that are a dangerous health risk in ready-to-eat meals. Contact between the baking cavity or vessel walls and the multi-layered food product together with steam pressure in the baking vessel results in reducing the baking time of the multi layered food product from a conventional industry acceptable bake time of conventional baked products on a standard commercial or industrial convection or tunnel band oven from 18-25 minutes to a far more efficient and productive bake time of 90 to 360 seconds (and all values and ranges there between). This is an increased baking efficiency (e.g., 12 and 16.6 times, etc.) faster than conventional commercial or industrial baking methods. This is a significant increase in baking efficiency as compared to conventional commercial or industrial baking methods. It should be appreciated that while achieving greater baking speed, efficiency and safety, the method in accordance with the present disclosure continues to provide the better baking qualities such as a) a lighter and more airy eating quality, b) a more desirable organoleptic eating flavor provided by caramelization and/or browning, c) a more desirable shape that allows for the ideal preparation of a multi layered food product or sandwich which is crispy on the outside and light and airy on the inside, d) a shape that is fun and encourages children to eat, and/or e) a more desirable appearance. In an age of limited government, energy and human resources, and high demand for convenient food meals, the dramatic increase in baking speed facilitated by this invention provides an exponential increase in American food production capability and capacity.

According to another non-limiting aspect of the disclosure, the method can optionally further include the step of packaging, freezing, and storing the multi-layered food product after the dough layer has been partially or fully baked. When the multi-layered food product is frozen for storage, the frozen multi-layered food product can be reconstituted a) by being allowed to warm in an ambient temperature environment (e.g., placed on a countertop in a kitchen wherein the ambient temperature is 60-100° F., etc.) and then eaten when sufficiently warmed in the ambient temperature environment, b) heated in a microwave oven to heat the multi-layered food product to a desired eating temperature, c) heated in a combination of a microwave oven, oven, toaster oven or air fryer wherein the microwave oven is used to heat the filling and the oven or toaster oven is used to toast the multi-layered food product exterior, d) heated in an oven, toaster oven, air fryer or on a heating plate or stove top to heat the multi-layered food product to a desired eating temperature, and/or e) or heated in a kitchen apparatus that offers a dual combination of microwave and convection heating to both thaw and or core heat the filling center while simultaneously crisping the outer layer of the multi layered food product. The multi-layered food product can be optionally covered in ovenable crisping overwrap packaging film (e.g., vented overwrap packaging film) prior to being heated within an oven or toaster oven to increase crisping and/or to prevent over-baking and drying out the multi-layered food product. If the dough layer has only been partially baked prior to the freezing of the multi-layered food product, the multi-layered food product can be heated for a sufficient time period to obtain the desired amount of baking of the dough layer prior to consumption of the multi-layered food product.

According to another non-limiting aspect of the disclosure, there is provided a method for forming a multi-layered food product, wherein the dough layer encapsulates about 70-100% of the filling (and all values and ranges therebetween). The dough layer is baked for a time period such that the dough layer is 50-100% fully baked (and all values and ranges therebetween), and typically the dough layer is baked for a time period such that the dough layer is 75-100% fully baked. The method can optionally include the step of partially or fully baking the dough layer in a bi-molded plate assembly that has a central cavity that can form a closed enclosure during the baking of the multi-layered food product. One or both of the plates of the bi-molded plate assembly include a cavity that is designed to partially or fully receive the multi-layered food product when the two plates are positioned together to form a closed central cavity. When closed, the closed baking cavity can mean the cavity is between 90% and 100% closed and all values and ranges therebetween. Typically, the baking cavity is between 98% and 100% closed or fully mated when in the closed position. When the baking cavity or vessel is open, it can be 10-100% (and all values and ranges therebetween) open and all values therebetween. One purpose of having the baking cavity partially or fully open for a period during the baking of the multi-layered food product while being baked in the oven is to allow the multi-layered food product to expand and/or be light and airy which can be a desired quality of the baked multi-layered food product. This can also be accomplished by oversizing the baking cavity so that even when closed, the multi-layered food product has room to expand while baking and can be light and airy before reaching the cavity walls of the baking cavity. As such, one non-limiting purpose of partially or fully closing the baking cavity or vessel about the multi-layered food product is to trap the multi-layered food product in the baking cavity for the purpose of a) providing caramelization and in turn an appealing color to the multi-layered food product, b) imparting increased flavor to the multi-layered food product through increased browning and caramelization, c) and or increase the pressure in the baking cavity which increases the baking pressure and thus expansion of the multi-layered food product, and reduces the bake time of the multi-layered food product, and/or d) trapping and shaping the multi layered food product so that it can later fit into a conventional toaster or related reconstitution apparatus. It should be noted that at the essence of the present disclosure is the process of striking a balance between allowing the multi layered food product to bake freely or open and achieve the light and airy desired quality of a successful baked product while also employing the shaped cavity vessel, whether fully closed or intermittently open to achieve the highly desired points a) through e) noted in the preceding sentence which provide important other significant and essential qualities to a successful commercially baked multi layered food product in today's competitive and discerning food marketplace. As such, the use of an over-sized baking cavity to bake the multi-layered food product as a light and airy product for a period before reaching the baking cavity walls can be done to provide for caramelization, color, appearance, and/or flavor to the multi-layered food product.

According to another non-limiting aspect of the disclosure, the baking method to produce the multi-layered food product can optionally include a single partially or fully closed cavity baking period process to bake the product or a fully open single stage baking process to bake the multi layered food product and or the baking method can include a period of partially and or fully closed period of baking followed by a partially or fully open topped baking period (and optionally a third stage partially or fully closed baking period) (e.g., an intermittent baking process between closed and open topped baking). The baking cavity can be rotated or flipped between open or closed topped baking periods. The baking method can include multiple baking periods that are regular or intermittent switching between open or closed topped baking periods. For instance, the baking cavity can begin the baking process open for a period 10 seconds to 28 minutes (and all values and ranges therebetween) and then flip, rotate, mate or receive a top or partial topped cavity and continue baking for an additional period of 10 seconds to 28 minutes (and all values and ranges therebetween). The baking period could then conclude. Alternatively, it should be appreciated that the baking method could include an additional period of time greater or lesser than the initial periods of bake time again open or partially open topped before completing the baking process. This baking method can work in any order and include any number of rotations and or baking periods open or closed. Similarly, as noted, the entire baking process can proceed inside a partially or fully closed baking cavity or vessel, with or without flipping or inverting the plate or baking vessel. Alternatively, the entire baking process can proceed inside a partially or completely open baking cavity or vessel. The shape of the cavity is non-limiting (e.g., puck shaped, cylindrical shaped, waffle-shaped, waffle surface patterned with pockets, disc or saucer-shaped body, star-shaped, cube-shaped, box-shaped, etc.).

Another non-limiting aspect of the invention is the increased speed and efficiency of this baking method in relation to historical processes or methods to prepare a hand-held meal or sandwich type product. Conventional preparation processes of hand-held meals typically involve a process commonly known as “pre-plating.” This method involves the separate preparation of the hand-held or sandwich type components, such as previously cooked and portioned meat, cheese, eggs, sauces, condiments, vegetables etc., plus the separate preparation of individual bread components including top and bottom bread components, such as top and bottom bun halves, top and bottom bagel halves, croissant halves, top and bottom English muffin halves, top and bottom waffle halves, etc. Further, this common method includes the slow, inefficient, and expensive process of assembling these components into the hand-held food product. This process includes assembling all the individual components at separate points in the assembly area and then layering the components individually within the bread. In one non-limiting example, there is provided a method for forming a conventional, or industry standard pre-plated English muffin breakfast sandwich that includes the steps: A bottom half (pre-baked) English muffin is laid onto the assembly conveyor by an individual laborer or rarely with a machine. A condiment may be deposited atop the bottom English muffin layer. Next a pre-cooked sausage or ham layer is placed atop the pre-baked bottom English muffin layer. Next, a prepared cheese slice layer would be placed atop the meat layer. Again, typically by hand, but rarely by a mechanized process. Next, a pre-cooked and shaped egg patty layer would be placed atop the cheese later. Optionally, an additional condiment layer could be placed upon the egg layer. Next, the pre-baked top English muffin is placed atop the 5 or 6 previously applied layers of the sandwich product. It should be appreciated that according to this common and conventional industry wide manufacturing process, the filling layers can vary, such as a cheeseburger, or grilled chicken sandwich, and the filling layers can be stacked within the breading in any order. Once fully, if awkwardly assembled, the meal is transported further down the assembly line and overwrapped in packaging, such as polypropylene plastic, to keep the many components from falling apart when being boxed, shipped, sold and later prepared. The hand-held meal is typically “gas flushed” when overwrapped if sold refrigerated to extend the refrigerated shelf-life or it's frozen to attain a much longer shelf life. In the United States, Americans consume approximately 300,000,000 sandwiches every day or 109.5 billion sandwiches per year. Nearly all of these sandwiches are prepared by the method just described as pre-plating whether made commercially as just described above or by using the same general method of pre-baking and pre-cooking the individual components and then hand-stacking and assembling them at home or at a fast-food or traditional restaurant. It is estimated that at least 50 billion of the sandwiches consumed in the US each year are prepared commercially or industrially. The closed or partially closed or closed and open-topped multi-layered food product preparation method described by the present disclosure allows for the multi-layered ready to eat food product to be prepared between 30% and 50% faster than the conventional process of preparing a multi-layered commercial food product in the USA marketplace. Further, the method in accordance with the present disclosure allows for the preparation of the described multi-layered food product at between 30% and 60% less cost than the current industrial manufacturing processes of pre-plating layered food products, such as sandwiches. This cost savings is imperative to Americans at a time when it is essential to protect the US food supply given multiple agricultural and environmental threats to the food supply. It should be further appreciated that the conventional method of commercial and industrial hand-held meal or sandwich preparation is very inefficient in time, labor and cost. This is unfavorable to American consumers. In addition to being expensive, it is less food safe than the methodology described by the present disclosure, since, as noted, the provided invention obtains heat-treatment or a kill step. As stated above, the conventional pre-plating method is 30% to 60% less efficient than the method described in the present disclosure. During the partial or full baking of the dough layer of the multi-layered food product, the closed central cavity at least partially entraps steam and/or other gasses generated during the baking of the dough layer and the heating of the filling, thereby causing a pressure increase in the central cavity during the partial or full baking of the dough layer of the multi-layered food product. Such pressure increase in the central cavity can facilitate in the baking of the dough layer. The method can optionally further include the step of partially or fully proofing the dough layer prior to the partial or full baking of the dough layer. Generally, the dough layer, when proofed, is allowed to proof for a time period to enable the dough to be 50-100% proofed (and all values and ranges therebetween), and typically is allowed to proof for a time period to enable the dough to be 80-100% proofed. The method can optionally further include the step of shaping the dough layer after the dough layer has partially or more typically fully encapsulated the filling and prior to the partial or full baking of the dough layer. In one non-limiting embodiment, the dough layer that includes the filling is shaped into a generally puck-shape; however, it can be appreciated that the dough layer can be shaped into other shapes (e.g., rectangular, circular, ovoid, square, triangular, cylindrical, star, or any other polygonal shape). During the optional shaping of the dough layer, the top of the dough layer is generally pressed downwardly such that the top and bottom portions of the dough layer that includes the fillings are flattened. Generally, the average height to maximum width ratio of the shaped dough layer is 1:2, or 1:3, or 1:4. The shaping of the dough layer can be by hand and/or by a machine. The method can optionally further include the step of packaging, freezing, and storing the multi-layered food product. When the multi-layered food product is frozen for storage, the frozen multi-layered food product can simply be a) allowed to warm in an ambient temperature environment (e.g., placed on a countertop in a kitchen wherein the ambient temperature is 60-100° F., etc.) and then eaten when sufficiently warmed in the ambient temperature environment, b) heated in a microwave oven to heat the multi-layered food product to a desired eating temperature, c) heated in a combination of a microwave oven and oven, toaster oven or air fryer wherein the microwave oven is used to heat the filling and the oven or toaster oven is used to toast the multi-layered food product exterior, or d) heated in an oven or toaster oven, air fryer or on a heating plate or stove top to heat the multi-layered food product to a desired eating temperature. The multi-layered food product can be optionally covered in oven-able crisping overwrap packaging film (e.g., vented overwrap packaging film) prior to being heated within an oven or toaster oven to increase crisping and/or to prevent over-baking and drying out the multi-layered food product. If the dough layer has only been partially baked prior to the freezing of the multi-layered food product, the multi-layered food product can be heated for a sufficient time period to obtain the desired amount of baking of the dough layer prior to consumption of the multi-layered food product. According to another non-limiting aspect of the disclosure, the one or more toppings can be applied to the dough layer via any commercially viable approach such as, but not limited, to a) sprinkling the one or more toppings by hand onto the dough layer, b) a topping hand-shaker with various diameter openings on the lids or top of the shakers to control the amount of the one or more toppings being applied to the dough layer, and/or c) using any commercially available topping applicator machine(s) to apply the one or more toppings to the dough layer. When a topping applicator machine is used, such machine can vary its aperture in order to target the center of the multi-layered food product and to provide even topping coverage over the top of the dough layer. A topping layer can be applied before or after the optional shaping step of the multi-layered food product or the optional topping layer can be applied during the baking process when the bi-molded top and bottom plates are open. If the optional topping layer is applied during baking it can be applied on top, on the sides, or on the bottom of the multi-layered food product.

One non-limiting object of the present disclosure is the provision of a multi-layered food product that includes a filling, a dough layer about the filling, and optionally one or more toppings on the dough layer.

Another non-limiting object of the present disclosure is the provision of multi-layered food product that includes a filling, a dough layer about the filling, and optionally one or more toppings on the dough layer, and wherein the dough layer is a yeast-containing dough layer.

Another non-limiting object of the present disclosure is the provision of a multi-layered food product that includes a filling, a dough layer about the filling, and optionally one or more toppings on the dough layer, and wherein the dough layer is a non-yeast-containing dough layer.

Another non-limiting object of the present disclosure is the provision of a multi-layered food product that includes a filling, a dough layer about the filling, and optionally one or more toppings on the dough layer, and wherein the dough layer is both a yeast-containing and chemical leavening containing dough layer.

Another non-limiting object of the present disclosure is the provision of a multi-layered food product that includes a filling, a dough layer about the filling, and optionally one or more toppings on the dough layer, and wherein the dough layer is a baking powder or baking soda-containing dough layer.

Another and/or alternative non-limiting object of the present disclosure is the provision of a multi-layered food product that includes a filling, a yeast-containing dough layer about the filling, and optionally one or more toppings on the dough layer.

Another and/or alternative non-limiting object of the present disclosure is the provision of a multi-layered food product that includes a filling, a yeast-containing or non-yeast containing dough layer about the filling, and optionally one or more ingredients within the dough layer.

Another and/or alternative non-limiting object of the present disclosure is the provision of a multi-layered food product that includes a yeast-leavened dough which provides structural integrity to the multi-layered food product to facilitate eating by hand.

Another and/or alternative non-limiting object of the present disclosure is the provision of a multi-layered food product that includes a yeast-leavened dough or non-yeast leavened dough which provides structural integrity and helps to shape the filling within the multi-layered food product to facilitate eating by hand.

Another and/or alternative non-limiting object of the present disclosure is the provision of a multi-layered food product that can be initially warmed in a microwave oven and then reconstituted in an oven or toaster to yield a multi-layered food product having a crispy exterior and a softer interior with or without the consistency of a typical yeast-leavened bread product.

Another and/or alternative non-limiting object of the present disclosure is the provision of a multi-layered food product that has a dough layer formed about the filling to substantially or fully encapsulate the filling.

Another and/or alternative non-limiting object of the present disclosure is the provision of a multi-layered food product wherein the filling in the multi-layered food product generally constitutes about 2-80 wt. % of the multi-layered food product.

Another and/or alternative non-limiting object of the present disclosure is the provision of a multi-layered food product wherein the dough layer is formulated to both shape the filling in the cavity of the dough layer and give the multi-layered food product structure so that the multi-layered food product can be eaten by the hand of a user without falling apart.

Another and/or alternative non-limiting object of the present disclosure is the provision of a multi-layered food product wherein the dough layer is formulated for elasticity and structure to stretch uniformly around the filling, shape the filling, provide a supportive structure to the multi-layered food product structure so that the multi-layered food product can be eaten by the hand of a user without falling apart, and while holding its shape. It should be noted that conventional multi-layered food products, such as “pre-plated” sandwiches, fall apart and are messy when eaten. This isn't acceptable given that contemporary Americans rely on convenience and eating meals while on-the-go.

Another and/or alternative non-limiting object of the present disclosure is the provision of a multi-layered food product wherein the dough layer is formulated to provide a light and airy breading layer.

Another and/or alternative non-limiting object of the present disclosure is the provision of a multi-layered food product wherein the dough layer is formulated to provide distinctive, attractive and compelling organoleptic qualities that appeal to consumers.

Another and/or alternative non-limiting object of the present disclosure is the provision of a multi-layered food product wherein the dough layer is typical of a savory yeasted or non-yeasted English muffin.

Another and/or alternative non-limiting object of the present disclosure is the provision of a multi-layered food product wherein the dough layer is typical of a savory bagel.

Another and/or alternative non-limiting object of the present disclosure is the provision of a multi-layered food product wherein the dough layer is typical of a croissant.

Another and/or alternative non-limiting object of the present disclosure is the provision of a multi-layered food product wherein the dough layer is typical of a savory pizza dough, French bread, Brioche, Ciabatta, or Italian bread or any other savory bread.

Another and/or alternative non-limiting object of the present disclosure is the provision of a multi-layered food product wherein the dough layer is gluten free.

Another and/or alternative non-limiting object of the present disclosure is the provision of a multi-layered food product wherein the dough layer is typical of yeast raised brioche breading that can be either savory or sweet or a combination of savory and sweet.

Another and/or alternative non-limiting object of the present disclosure is the provision of a multi-layered food product wherein the dough layer is formulated to be typical of a sweet breading such as a sweet yeast raised waffle.

Another and/or alternative non-limiting object of the present disclosure is the provision of a multi-layered food product wherein the dough layer is formulated to be typical of a savory breading such as a yeast raised waffle.

Another and/or alternative non-limiting object of the present disclosure is the provision of a multi-layered food product wherein the dough layer is formulated to be typical of any sweet bread such as a cinnamon roll, brioche, ciabatta, or any sweet breading.

Another and/or alternative non-limiting object of the present disclosure is the provision of a multi-layered food product wherein the dough layer, prior to baking, includes flour, water containing component including milk, leavening agent, and optionally, flavorings and/or spices, salt, milk powder, gluten, sweetener, shortening, and/or eggs and optional other ingredients.

Another and/or alternative non-limiting object of the present disclosure is the provision of a multi-layered food product wherein the dough layer, prior to baking, includes 25-90 wt. % flour, 20-60 wt. % water-containing component, 0.2-12 wt. % leavening agent, 0-20 wt. % milk powder, 0-50 wt. % eggs, 0-9 wt. % gluten, 0)-50 wt. % sweetener, 0-30 wt. % shortening, 0-5 wt. % salt, and 0-5 wt. % flavoring agent.

Another and/or alternative non-limiting object of the present disclosure is the provision of a multi-layered food product wherein the dough layer, prior to baking, includes yeast, wherein the yeast constitutes 0-100% of the leavening agent in the dough layer.

Another and/or alternative non-limiting object of the present disclosure is the provision of a multi-layered food product wherein the dough layer, prior to baking, includes no leavening except for that naturally occurring in eggs or other non-typical leavening ingredients.

Another and/or alternative non-limiting object of the present disclosure is the provision of a multi-layered food product wherein the dough layer, prior to baking, includes both yeast and baking powder or baking soda each at amounts between 5% and 95% of the leavening agent in the dough layer.

Another and/or alternative non-limiting object of the present disclosure is the provision of a multi-layered food product wherein the dough layer, prior to baking, includes chemical leavening such as baking powder and or baking soda, wherein the chemical leavening constitutes 0-100% of the leavening agent in the dough layer.

Another and/or alternative non-limiting object of the present disclosure is the provision of a multi-layered food product wherein the dough layer, prior to baking, includes eggs to facilitate in creating structure and stability within the dough layer, thickening the dough layer, adding moisture to the dough layer, adding flavor to the dough layer, and/or improving the rising of the dough layer during the proofing and baking of the dough layer.

Another and/or alternative non-limiting object of the present disclosure is the provision of a multi-layered food product wherein the dough layer, prior to baking, includes gluten to facilitate in providing structure to the dough layer.

Another and/or alternative non-limiting object of the present disclosure is the provision of a multi-layered food product wherein the dough layer, prior to baking, does not include gluten in the dough layer.

Another and/or alternative non-limiting object of the present disclosure is the provision of a multi-layered food product wherein the dough layer, prior to baking, has toppings that are applied to the top of the multi layered food product.

Another and/or alternative non-limiting object of the present disclosure is the provision of a multi-layered food product wherein the dough layer, prior to baking, has one or more additional ingredients within the dough layer.

Another and/or alternative non-limiting object of the present disclosure is the provision of a multi-layered food product wherein the dough layer, during baking, has toppings that are applied to the top, bottom and/or sides of the multi layered food product during the baking process.

Another and/or alternative non-limiting object of the present disclosure is the provision of a multi-layered food product wherein the dough layer, prior to baking, has toppings applied to the bottom of the multi layered food product.

Another and/or alternative non-limiting object of the present disclosure is the provision of a multi-layered food product wherein the dough layer, prior to baking, has toppings that are applied to the top, bottom and/or sides of the multi layered food product.

Another and/or alternative non-limiting object of the present disclosure is the provision of a multi-layered food product wherein the dough layer, prior to baking, has a viscosity of about 100,000-1,500,000 cps at 21° C. such that the dough cannot be poured about the filling at 21° C.

Another and/or alternative non-limiting object of the present disclosure is the provision of a multi-layered food product wherein the dough layer, prior to baking, constitutes about 20-95% wt. % of the multi-layered food product.

Another and/or alternative non-limiting object of the present disclosure is the provision of a multi-layered food product wherein the multi-layered food product is formed using an automated assembly line system.

Another and/or alternative non-limiting object of the present disclosure is the provision of a method for forming a multi-layered food product that includes a) providing a filling, b) providing a dough layer, c) partially or fully encapsulating the filling in the dough layer, d) partially or fully baking the dough layer, and e) optionally packaging and/or freezing the multi-layered food product.

Another and/or alternative non-limiting object of the present disclosure is the provision of a method for forming a multi-layered food product that includes a) providing a filling, b) providing a dough layer, c) partially or fully encapsulating the filling in the dough layer, d) optionally applying one or more toppings to the dough layer before or during baking, e) proofing the dough filled product prior to toppings or after applying toppings, f) partially or fully baking the dough layer, and g) optionally packaging and/or freezing the multi-layered food product.

Another and/or alternative non-limiting object of the present disclosure is the provision of a method for forming a multi-layered food product wherein the dough layer is baked for a time period such that the dough layer is 50-100% fully baked, but typically 100% baked.

Another and/or alternative non-limiting object of the present disclosure is the provision of a method for forming a multi-layered food product further including the step of partially or fully proofing the dough layer prior to the partial or full baking of the dough layer.

Another and/or alternative non-limiting object of the present disclosure is the provision of a method for forming a multi-layered food product further including the step of shaping or flattening the dough layer after the dough layer has partially or fully encapsulated the filling and prior to the partial or full baking of the dough layer.

Another and/or alternative non-limiting object of the present disclosure is the provision of a method for forming a multi-layered food product wherein the average height to maximum width ratio of the shaped dough layer is generally 1:1 to 1:4 (and all values and ranges therebetween).

Another and/or alternative non-limiting object of the present disclosure is the provision of a method for forming a multi-layered food product including the use of a cooking surface that can form an open or fully enclosed cavity about the dough layer of the multi-layered food product during the partial or full baking of the dough layer.

Another and/or alternative non-limiting object of the present disclosure is the provision of a method for forming a multi-layered food product including the use of a cooking surface that includes first and second plates that when placed together can form a partially or fully enclosed cavity about the dough layer of the multi-layered food product during the partial or full baking of the dough layer.

Another and/or alternative non-limiting object of the present disclosure is the provision of a method for forming a multi-layered food product including the use of a cooking surface that includes first and second (top and bottom) baking plates with patterned surfaces, such as a waffle grid, that include a recessed cavity within the patterned baking surface of the baking plates that when placed together can form a protective baking cavity (pocket) to protect the filling within the dough layer of the multi-layered food product during the partial or full baking of the dough layer.

Another and/or alternative non-limiting object of the present disclosure is the provision of a method for forming a multi-layered food product including the use of a cooking surface that includes first and second plates that when placed together can form a partially open or completely open baking cavity that is larger than the unbaked multi-layered food product so that the multi-layered food product has room to expand while baking so that the multi-layered food product becomes light and airy during the baking process of the multi-layered food product during the partial or full baking of the dough layer.

Another and/or alternative non-limiting object of the present disclosure is the provision of a method for forming a multi-layered food product including the use of a cooking surface that includes first and second plates that when placed together can form a partially open or completely open baking cavity that is larger than the unbaked multi-layered food product so that the multi-layered food product has room to expand while baking so that the multi-layered food product becomes light and airy during the baking process of the multi-layered food product during the partial or full baking of the dough layer but that allows the multi-layered food product to reach or press against the heated baking surfaces of the baking cavities to provide caramelization, color, crisping and flavor to the baked multi-layered food product.

Another and/or alternative non-limiting object of the present disclosure is the provision of a method for forming a multi-layered food product including the use of a cooking surface that includes first and second plates that when placed together can form a partially open or completely open baking cavity that is larger than the unbaked multi-layered food product so that the multi-layered food product has room to expand while baking so that the multi-layered food product becomes light and airy during the baking process of the multi-layered food product during the partial or full baking of the dough layer, and during this baking process the bi-molded baking plates, top and bottom, can be rotated to encourage thorough light and airy baking and color appearance and flavor.

Another and/or alternative non-limiting object of the present disclosure is the provision of a method for forming a multi-layered food product including the use of a cooking surface that includes first and second plates that when placed together can form a partially open or completely open baking cavity about the dough layer of the multi-layered food product during the partial or full baking of the dough layer.

Another and/or alternative non-limiting object of the present disclosure is the provision of a method for forming a multi-layered food product wherein during the cooking process, the first and second cooking plates are rotated about a central axis of the multi-layered food product to facilitate the even cooking, browning, baking and increased lightness of the dough layer during the partial or full baking of the multi layered food product.

Another and/or alternative non-limiting object of the present disclosure is the provision of a method for forming a multi-layered food product further including the step of packaging, freezing and storing the multi-layered food product after the dough layer has been partially or fully baked.

Another and/or alternative non-limiting object of the present disclosure is the provision of a method for forming a multi-layered food product further including the step of heating the frozen multi-layered food product by a) allowing the multi-layered food product to warm in an ambient temperature environment (e.g., placed on a countertop in a kitchen wherein the ambient temperature is 60-100° F., etc.) and then eaten when sufficiently warmed in the ambient temperature environment, b) heating in a microwave oven to heat the multi-layered food product to a desired eating temperature, c) heating in a combination of a microwave oven and oven, toaster oven or air fryer wherein the microwave oven is used to heat the filling and the oven or toaster oven is used to toast the multi-layered food product exterior, d) heated in an oven, toaster oven, air fryer or on a heating plate or stove top to heat the multi-layered food product to a desired eating temperature, e) or heated in an apparatus which utilizes both microwave and convection to simultaneously core heat and crisp the outside of the previously frozen multi layered food product.

Another and/or alternative non-limiting object of the present disclosure is the provision of optionally covering the multi-layered food product in ovenable crisping overwrap packaging film (e.g., vented overwrap packaging film) prior to being heated within an oven or toaster oven to increase crisping and/or to prevent over-baking and drying out the multi-layered food product.

Another and/or alternative non-limiting object of the present disclosure is the provision of a multi-layered food product that has one or more toppings that constitutes about 0.1-15 wt. % (and all values and ranges therebetween) of the multi-layered food product.

Another and/or alternative non-limiting object of the present disclosure is the provision of a multi-layered food product that has one or more toppings that constitutes about 3-7 wt. % of the multi-layered food product.

Another and/or alternative non-limiting object of the present disclosure is the provision of a multi-layered food product that has one or more toppings that improves the taste, flavor impact, and appearance of the multi-layered food product.

Another and/or alternative non-limiting object of the present disclosure is the provision of a multi-layered food product that has one or more toppings that are applied to the top or bottom or both the top and bottom of the multi-layered food product.

Another and/or alternative non-limiting object of the present disclosure is the provision of a multi-layered food product that has one or more additional ingredients within the dough layer that improves the taste, flavor impact, nutrition and appearance of the multi-layered food product.

Another and/or alternative non-limiting object of the present disclosure is the provision of a multi-layered food product that has one or more toppings that are comingled and bonded to the dough layer to inhibit or prevent 1) the release of the one or more toppings from the dough layer, and/or 2) mess and cleanup.

Another and/or alternative non-limiting object of the present disclosure is the provision of a multi-layered food product that has one or more toppings that are at least partially caramelized when the dough layer is partially or fully baked, and wherein the caramelization of the one or more toppings 1) provides additional flavor impact to the multi-layered food product, 2) and or provides better more appetizing appearance to the multi-layered food product, and/or 3) improves the bonding of the caramelized topping to the dough layer.

According to another non-limiting aspect of the disclosure, the one or more toppings can be applied by 1) sprinkling the one or more toppings by hand onto the dough layer, —b) using a topping hand-shaker with various diameter openings on the lids or top of the shakers to control the amount of the one or more toppings being applied to the dough layer, and/or c) using any commercially available topping applicator machine(s) to apply the one or more toppings to the dough layer.

These and other advantages of the present disclosure will become more apparent to those skilled in the art from a review of the description of the preferred embodiment and claims.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1A is a perspective view of a multi-layered food product in accordance with another aspect of the present disclosure;

FIG. 1B is a cross-sectional view taken along Line 1B-1B in FIG. 1A;

FIG. 1C is a cross-sectional view taken along Line 1B-1B in FIG. 1A, but the multi-layered food product further includes a topping;

FIG. 1D is a cross-sectional view of a stuffed waffle-shaped product;

FIGS. 2 and 2A are schematic diagrams showing an automated assembly line system used to form the multi-layered food product of the present disclosure;

FIG. 3 is a schematic diagram showing an alternative configuration of the automated assembly line system in FIGS. 2 and 2A;

FIG. 4A is a perspective view of a second bi-molded plate assembly for forming the multi-layered food product, the second bi-molded plate assembly comprising a lid member and a receptacle member;

FIG. 4B is a side view of the second bi-molded plate assembly in FIG. 4A;

FIG. 5A is a side view of the lid member shown in FIG. 4A;

FIG. 5B is a top view of the lid member shown in FIG. 5A;

FIG. 6A is a side view of the receptacle member shown in FIG. 4A;

FIG. 6B is a top view of the receptacle member shown in FIG. 6A;

FIG. 6C is another side view of another non-limiting configuration of a bi-molded plate assembly reflecting another aspect of the present disclosure reflecting a waffle grid pattern on the surface of the lid and receptacle members of the bi-molded plate assemble as well as a baking pocket created by having an additional recessed pockets, or filling pocket, space to accommodate and maintain the integrity of the filling within the bi-molded baking plate assembly, and wherein the grid (in this case a waffle grid) can have the grid (teeth) optionally softened or rounded to further protect the integrity of the filling from sharp edges;

FIG. 7 is a process flow diagram illustrating a further aspect of the method for forming a multi-layered food product;

FIG. 8 is a process flow diagram illustrating a method for forming a multi-layered food product according to another aspect of the present disclosure; and

FIG. 9 is a schematic diagram showing an alternative configuration of the automated assembly line system in FIG. 3.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the case of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

Referring now to the drawings wherein the showings are for the purpose of illustrating non-limiting embodiments of the disclosure only and not for the purpose of limiting same, the figures illustrate various non-limiting embodiments of the multi-layered food product and a method for manufacturing the same in accordance with the present disclosure.

The present disclosure relates generally to filled food products, and more particularly to a multi-layered food product and method for forming the multi-layered food product. The multi-layered food product can be optionally initially warmed in a microwave and then heated in an oven, or toaster, or air fryer.

Although a puck-shaped and waffle shaped configuration is shown, the multi-layered food product can have other shapes, such as rectangular, circular, ovoid, square, triangular, cylindrical, star, or any other polygonal shape. As can also be appreciated, the multilayered food product does not need to be molded. The shaped configuration of the multi-layered food product gives the multi-layered food product the appearance of a home-baked meal or snack that has been prepared on a griddle, pan or panini. Although the multi-layered food product is shown as having a puck-shaped or waffle-shaped configuration, it will be appreciated that the product can have any desirable shape and size that makes the multi-layered food product versatile and easy to consume. For example, the multi-layered food product can have any shape and size that enables a consumer to easily eat the multi-layered food product at home or on-the-go without any mess. The molded configuration of the multi-layered food product also allows the product to be quickly and easily heated for consumption in a microwave and/or toaster, or simply in an oven.

The multi-layered food product comprises a partially or fully baked insert that includes a filling, which filling is substantially (e.g., more than 50%, at least about 60%, at least about 70%, at least about 80% or at least about 90%) or typically completely enveloped or encapsulated by a dough. The dough is at least partially fully baked (baked 50-99% of full baked) or fully baked. The dough layer can include one or more fillings and/or be topped by one or more toppings. The one or more toppings can include flavored powders, seasonings, crumbs or clusters, grated cheeses, meats, sugars, vegetables, fruits, eggs, and/or any other food topping and/or filling. Butter and/or oil can be optionally applied to the one or more toppings (e.g., spray coating, brush coating, etc.) to facilitate in the partial or full caramelization of one or more of the toppings during the baking process, and to help prevent the toppings from sticking to the baking cavity. The butter and/or oil can be applied prior to, during or after the one or more toppings are applied to the dough layer.

The multi-layered food product can have a molded configuration (e.g., a puck-like shape, cylindrical-shaped, cube-shaped, waffle-shape, etc.). As noted above, the baked insert optionally includes a filling that is substantially or completely enveloped or encapsulated by the dough. The filling 16, when used, can comprise any desired solid or semi-solid food product that is typically included as part of a meal or snack. Non-limiting examples of fillings can include, but are not limited to, fruit, cheese, eggs, meat (e.g., ham, bacon, sausage, hamburger, chicken, turkey, etc.), plant-based meat, tofu, vegetables, sauces, gravy, nuts, seeds, caramel, butterscotch, chocolate, fudge, confectionary, custard, pudding, marshmallow filling, etc. and/or a combination thereof.

The weight percent of the optional topping, the filling, and the dough can be varied to impart the multi-layered food product with the desired structural, appearance, and/or taste characteristics. In one non-limiting example of the present disclosure, the filling can be about 15-75 wt. % of the total weight of the multi-layered food product, the dough 18 can be about 10-60 wt. % of the total weight of the multi-layered food product, and the optional topping layer can be about 2-15 wt. % of the total weight of the multi-layered food product.

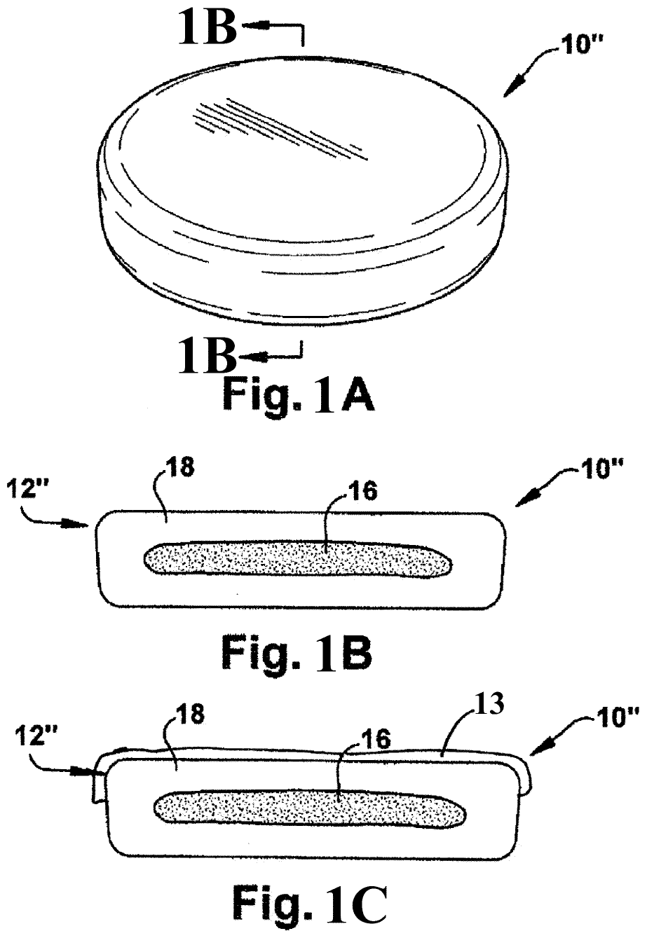

Referring now to FIGS. 1A-1D, there is illustrated a multi-layered food product 10″ according to one aspect of the present disclosure. The multi-layered food product 10″ can have a molded configuration (e.g., puck-shaped, waffle-shaped, etc.). Although the multi-layered food product 10″ is shown as having a puck-shaped configuration or square waffle-shaped configuration, it will be appreciated that the product can have any desirable shape and size that makes the product versatile and easy to consume (e.g., star-shaped waffle, flower-shaped waffle, circular-shaped waffle, square-shaped puck, etc.). For example, the multi-layered food product 10″ can have any shape and size that enables a consumer to easily eat the multi-layered food product at home or on-the-go without any mess. The molded configuration of the multi-layered food product 10″ also allows the product to be quickly and easily reconstituted for consumption in a microwave and/or toaster, air-fryer, or simply heated in an oven.

As shown in FIG. 1B, 1C, 1D, the multi-layered food product 10″ can comprise an insert 12″ including a filling 16 that is substantially (e.g., 70-99.99% encapsulated and all values and ranges therebetween) or completely enveloped or encapsulated by a dough 18 (which can optionally include additional dough ingredients 15), and optionally include one or more toppings 13 as illustrated in FIG. 1C that can include flavored powders, seasonings, crumbs or clusters, grated cheeses, meats, sugars, sauces, vegetables, fruits, eggs or any other food toppings. As described above, the filling 16 can include any desired solid or semi-solid food product that is typically included as part of a meal or snack. The multi-layered food product 10″ illustrated in FIGS. 1A-1D only includes a single dough layer (e.g., yeast-leavened dough layer or chemically-leavened dough layer, batter, dough that is absent leavened agent, etc.), a filling 16 that is partially or fully encapsulated by the dough layer, and an optional topping on the outer surface of the dough layer. As illustrated in FIGS. 1A-1C, the shape of the multi-layered food product 10″ is a generally pucked-shaped. As illustrated in FIG. 1D, the shape of the multi-layered food product 10″ is has a waffle-shaped appearance.

The weight percent of the filling 16, the dough 18, and the optional topping layer 13 can be varied to impart the multi-layered food product 10″ with desired structural and taste characteristics. In one example of the present disclosure, the filling 16 can be about 15-75 wt. % of the total weight of the multi-layered food product 10″ and the dough layer 18 can be about 25-75 wt. % of the total weight of the multi-layered food product, and the optional topping layer 13 can be about 1-11 wt. % of the total weight of the multi-layered food product. In another non-limiting example of the present disclosure, the filling layer 16 in the multi-layered food product 10″ can be about 55-65 wt. % of the multi-layered food product, the dough layer 16 of the multi-layered food product 10″ can be about 30-40 wt. % of the multi-layered food product, and the optional topping 13 of the multi-layered food product 10″ can be 0-10 wt. % of the multi-layered food product.

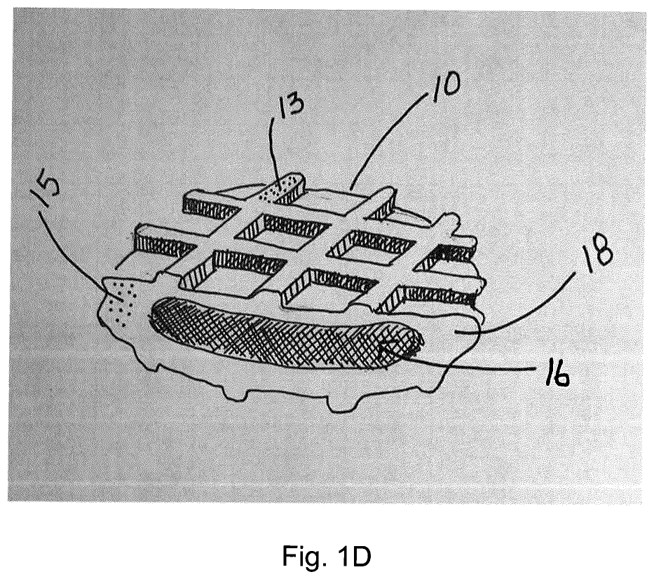

As illustrated in FIGS. 2, 2A, 3, 6C, 7, 8, and 9, another aspect of the present disclosure includes a method 30 and apparatus for forming a multi-layered food product 10″. The method 30 can be performed using an automated assembly line system (FIGS. 2, 2A, 3, and 9) comprising an automated assembly line 52, and automated line 200, and optional automated line 50.

Referring now to FIGS. 2 and 2A, the automated assembly line 52 for preparing the multi layered food product 10″ comprises a series of upper and lower loop-shaped tracts 54 and 56, a portion of each of which is disposed within an oven 80. The upper and lower tracts 54 and 56 of the automated assembly line 52 include a plurality of baking plates 60 securely mounted thereto that can be securely mated together to form a plurality of bi-molded plate assemblies 62.

Each of the bi-molded plate assemblies formed by each of the baking plates have a shaped configuration and form a cavity therebetween. As can be appreciated, the cavity can have any shape (e.g., cylindrical shaped, waffle-shaped, disc or saucer-shaped body, star-shaped, cube-shaped, box-shaped, etc.). The cavity is defined by first and second plates. The dimensions (e.g., height, width, length, cavity depth, etc.) of the first and second plates can be about equal so that the dimensions of the multi-layered food product 10″ formed by the method are also about equal or they can be split with any percentage being apportioned to the top or bottom plate and the remainder apportioned to the opposing plate (e.g., 5-100% (and all values and ranges therebetween) of the cavity is formed by the first plate and 5-100% (and all values and ranges therebetween) of the cavity is formed by the bottom plate; 30-70% of cavity formed by the first plate and 30-70% of the cavity formed by the second plate.

All or only a portion of each of the bi-molded plate assemblies can be made of a rigid, heat-conductive material (e.g., a metal or metal alloy), and the baking surface can optionally be coated with a non-stick baking surface such as Teflon or silicone.

During the partial or full baking of the dough layer 18 of the multi-layered food product 10″, the cavity formed by the heated first and/or second plates partially or fully entraps gasses (e.g., CO2, water vapor, etc.) in the cavity, thereby increasing the pressure in the cavity during the partial or full baking of the dough layer, which can 1) dramatically increase the rate of baking of the dough layer, 2) enhance the properties of the dough layer (e.g., dough strength, flavor, color), and/or 3) increase or maintain the moisture content of the partially or fully baked dough layer. The cavity also is used to create and maintain the shape of the multi-layered food product 10′ during the partial or full baking of the dough layer. The closed cavity can also result in a portion of the inner surface of the cavity pressing the one or more toppings 13 partially or fully into the dough layer, thereby facilitating in the securing of the one or more toppings to the dough layer; however, this is not required.

When the multi-layered food product 10″ is to be formed as illustrated in FIGS. 1A-1D, either the first automated assembly line 50 or the automated assembly line 52 or 200 is used to form the multi-layered food product 10″. As can be appreciated, for various multi-layered food products, automated assembly lines 50, 52 and 200 can optionally be used to individually partially or fully bake each of the various dough layers during different time periods.

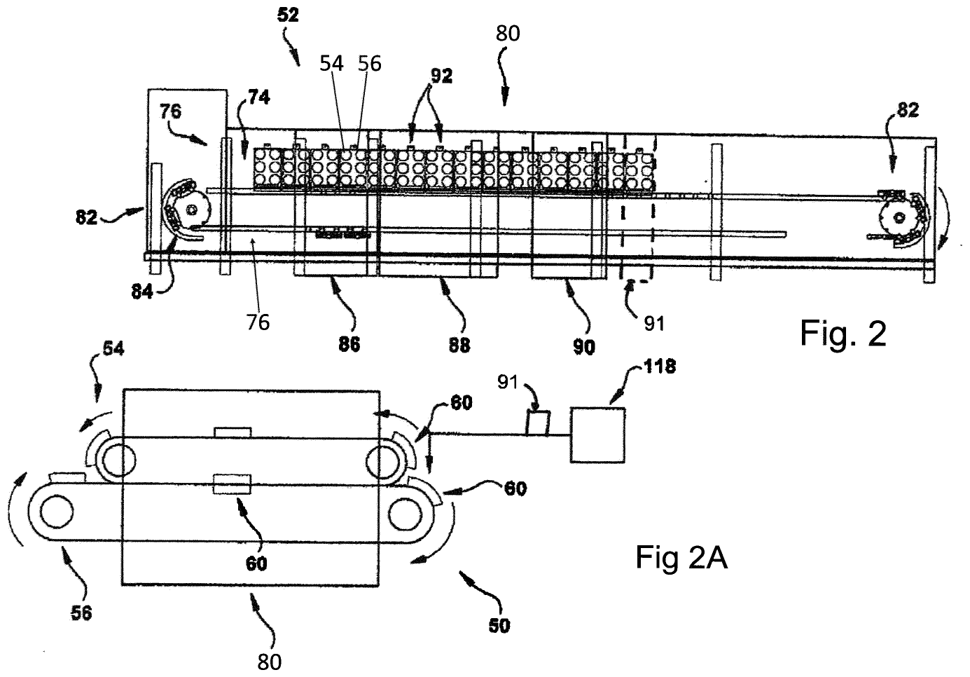

As shown in FIGS. 2, 2A and 3, the automated assembly line 52 is for preparing the multi-layered food product 10″ and comprises a continuous, loop-shaped tract 74 having an upper portion 76 and a lower portion 78. A portion of the assembly line 52 is seated within an oven 80. The tract 74 of the assembly line 52 is operably mated to opposing rotation members 82, each of which is separately or jointly powered by a power source (not shown). As described in greater detail below, the assembly line 52 also includes an automatic removing system 84, a filled dough feeding system 88, and can optionally include a topping applicator 91 (See FIGS. 2, 2A).

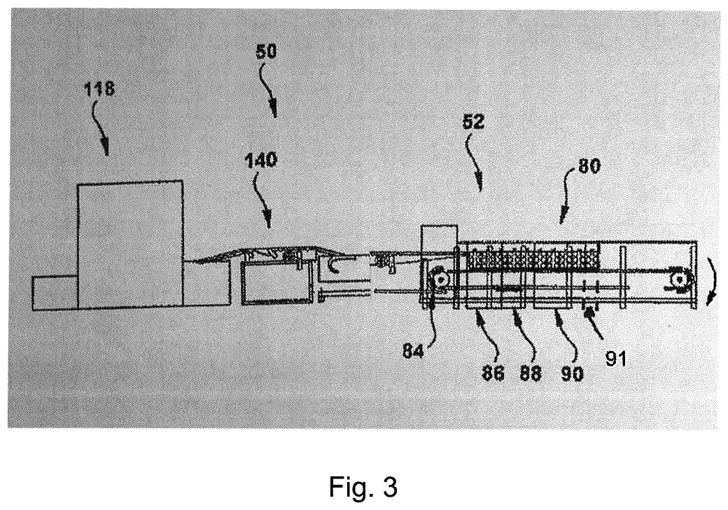

The assembly line 52 also includes a plurality of baking plates 92, each of which includes at least one of a bi-molded plate assembly 94 (FIGS. 4A-4B). As shown in FIG. 2, the assembly line 52 includes fourteen second baking plates 92 having six of the bi-molded plate assemblies 94 in each. It will be appreciated that the number of the baking plates 92, as well as the number of the bi-molded plate assemblies 94 comprising each of the baking plates, can be varied depending upon production needs and the configuration of the assembly line 52.

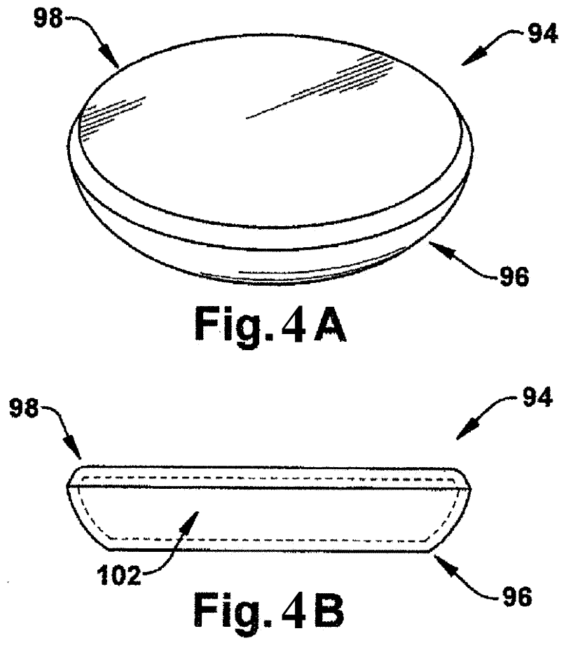

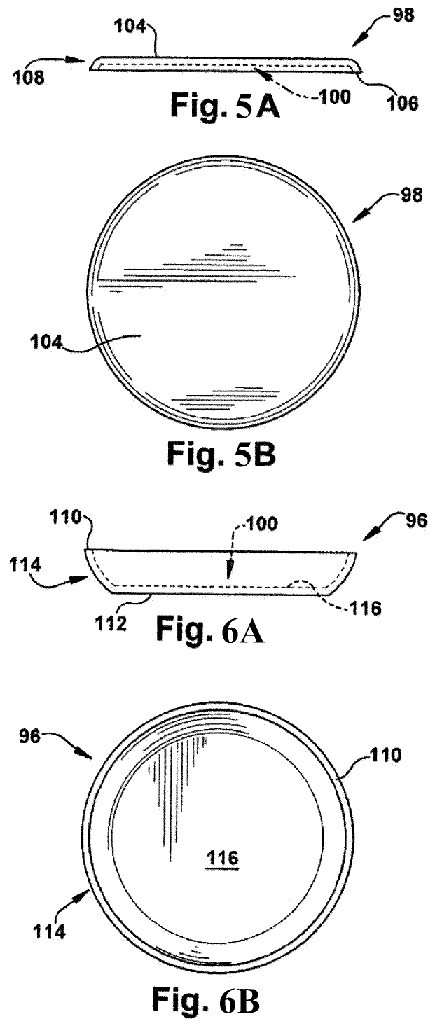

As shown in FIGS. 4A-4B, the bi-molded plate assemblies 94 comprises a receptacle member 96 and a lid member 98. All or only a portion of each of the bi-molded plate assemblies 94 can be made of a rigid, heat-conductive material (e.g., a metal or metal alloy). The receptacle member 96 (e.g., first plate) and the lid member 98 (e.g., second plate) are shown to have a generally circular or oval-shaped configuration and include a cavity 100 (FIGS. 5A and 6A). When the receptacle member 96 (FIG. 4B) and the lid member 98 are securely mated with one another, the cavities 100 of the lid member and the receptacle member form a molded, closed baking cavity 102. The shape of the closed cavity is non-limiting (e.g., puck-shaped, cylindrical-shaped, waffle-shaped, disc-shaped, saucer-shaped, star-shaped, cube-shaped, box-shaped, etc.). The molded, closed baking cavity 102 can have a diameter of 4 cm to about 25 cm (and all values and ranges therebetween), and a depth of about 1 cm to 10 cm (and all values and ranges therebetween); however, it can be appreciated that other sizes can be used. As illustrated in FIGS. 5A and 6A, receptacle member 96 has a larger cavity 100 and receptacle member 98 has a smaller cavity 100 such the majority of closed baking cavity 102 is formed by cavity 100 of receptacle 96. However, it can be appreciated that cavities 100 can be generally the same size as illustrated in the closed baking cavity 102 that is formed by first and second plates 96 and 98. The closed baking cavity 102 can optionally be configured to be larger (e.g., 0.1-200% larger in volume and all values and ranges therebetween) or the same size than the multi-layered dough product when the multi-layered dough product is contained with the closed baking cavity 102.

The molded, closed baking cavity 102 is designed to hold and bake the components of the multi-layered food product 10″ concurrently. Accordingly, the flavor of the multi-layered food product 10″ is enhanced through the process of baking the product components within the molded baking cavity 102. In addition to the leavening power that the multi-layered food product 10″ receives from the yeast or chemically leavened dough 18, the multi-layered food product receives further leavening from the steam generated within the sealed molded baking cavity 102 during the baking process. Also, the increased pressure generated in the closed cavity due to the generation of gasses (e.g., steam, CO2, etc.) during the partial or full baking of the multi-layered food product in the closed baking cavity 102 can facilitate in the bonding of one or more optional toppings 13 to the top surface of the dough layer (See FIG. 1C-multi-layered food product 10″). The closed cavity baking container or vessel can also result in a portion of the inner surface of the cavity pressing the one or more toppings partially or fully into the dough layer, thereby facilitating in the securing of the one or more toppings to the dough layer; however, this is not required. As can be appreciated, the dough can be absent yeast and chemical leavening agent.

The lid member 98 (FIG. 5A) (e.g., second plate) of each of the second bi-molded plate (e.g., first plate) assemblies 96 has a disc-like shape and is defined by oppositely disposed first and second major surfaces 104 and 106. As can be appreciated, the lid member 98 (e.g., second plate) of each of the second bi-molded plate (e.g., first plate) assemblies 96 can form other shaped cavities (e.g., cylindrical-shaped, waffle-shaped, saucer-shaped, star-shaped, cube-shaped, box-shaped, etc.). The first major surface 104 has a generally smooth, flat configuration that gradually tapers around the edge 108 towards the second major surface 106; however, this is not required. The second major surface 106 is adapted for mating with the receptacle member 96. As shown in FIG. 5A, the cavity 100 of the lid member 98 extends from the second major surface 106 towards the first major surface 104 such that the cavity is recessed within the second major surface. The cavity 100 of the lid member 98 defines a volume capable of holding up to about 100 vol. % (e.g., 0-100% and all values and ranges therebetween) of the multi layered food product 10″ during the baking process. In one non-limiting arrangement, the cavity 100 of the lid member 98 defines a volume capable of holding up to about 0-70 vol. % of the multi layered food product 10″ during the baking process. In another non-limiting arrangement, the cavity 100 of the lid member 98 defines a volume capable of holding up to about 5-30 vol. % of the multi-layered food product 10″ during the baking process.

As shown in FIGS. 6A-6B, the receptacle member 96 (e.g., first plate) has a rounded, pan-shaped configuration; however, this is not required. The receptacle member 96 includes oppositely disposed first and second major surfaces 110 and 112 and an annular side wall 114 that extends between the first and second major surfaces. The cavity 100 of the receptacle member 96 extends between the first major surface 110 and the bottom surface 116 of the receptacle member. The cavity 100 of the receptacle member 96 defines a volume that can be equal to or greater than the volume of cavity 100 of lid member 98. The cavity 100 of the receptacle member 96 is capable of holding about 0-100 vol. % (and all values and ranges therebetween) of the multi-layered food product 10″ during the baking process.

Referring now to FIG. 6C, another non-limiting receptacle member 94 is illustrated. The receptacle member 94 has a waffle-shape configuration. The lid member or second plate 98 has a bottom surface that include a plurality of spaced apart teeth 97. The receptacle member or first plate 96 includes a top surface that include a plurality of spaced apart teeth 99. As illustrated in FIG. 6C, when the lid member or second plate 98 and the receptacle member or first plate 96 are positioned together to form the closed baking cavity 102, the bottom surface of teeth 97 and the top surface of teeth 99 are spaced apart. Such spacing between the teeth 97, 99 allows the dough to flow between the teeth 97, 99 when the closed baking cavity 102 is formed so that the formed and baked waffle-shaped multi-layered food product does not have holes through the multi-layered food product. However, if it is desirable to form one or more openings through the baked waffle-shaped multi-layered food product, no spaced can be formed between one or more sets of bottom surface 105 of teeth 97 and the top surface 107 of teeth 99 are spaced apart when the closed baking cavity 102. Although not shown, the sides of the closed baking cavity 102 can be closed so that the little (e.g., 0-10% of the volume of the waffle-shaped multi-layered food product and all values and ranges therebetween) or no portion of the waffle-shaped multi-layered food product escapes or flows from the closed baking cavity 102 during the baking of the waffle-shaped multi-layered food product. As illustrated in FIG. 6C, there can be multiple different spacings between the teeth. As illustrated in FIG. 6C, the spacing between the teeth about the outer edge of the closed baking cavity 102 are the smallest. The spacing of the teeth that are spaced from the outer edge of teeth of the closed baking cavity 102 is larger than the spacing of the teeth about the outer edge of the closed baking cavity 102, but less than the spacing between the teeth in the central region of the closed baking cavity 102. As can be appreciated, other teeth spacing arrangement can be used.

As illustrated in FIG. 6C, a portion of all of the bottom surface of teeth 97 and/or the top surface of teeth 99 can be rounded or otherwise softened surfaces 121 so that the formed and/or baked waffle-shaped multi-layered food product are not cut, tear, damaged or sheared so as to adversely affect the appearance baked waffle-shaped multi-layered food product and to protect the integrity of the filling.

Referring again to FIG. 6C, the central portion of the closed baking cavity 102 has the largest spacing between the teeth of the bottom surface of teeth 97 and the top surface of teeth 99. Such spacing forms a filling pocket 103 such that when the lid member or second plate 98 receptacle member and the receptacle member or first plate 96 are positioned together to form the closed baking cavity 102, additional spacing is formed between the teeth so as to accommodate the filling in the multi-layered food product. For example, when the multi-layered food product (which is generally a coextruded multi-layered food product) is inserted onto receptacle member or first plate 96, and thereafter the lid member or second plate 98 is moved toward the receptacle member or first plate 96, or the lid member or second plate 98 receptacle member is otherwise moved together with the receptacle member or first plate 96, the multi-layered food product is squeezed between the lid member or second plate 98 and the receptacle member or first plate 96 and the filling pocket provides added spacing between the teeth so as to inhibit or prevent the filling from being pressured outside the outer perimeter of the dough layer and flow into the closed baking cavity 102, thus causing a) sticking of the baked multi-layered food product to the lid member or second plate 98 receptacle member and/or the receptacle member or first plate 96, b) adversely affecting the appearance of the baked multi-layered food product, c) damaging the multi-layered food product when being removed from the lid member or second plate 98 receptacle member and/or the receptacle member or first plate 96, d) over-cooking and/or under-cooking the filling, the dough material, and/or the optional one or more toppings, and/or e) interfere with the proper and desired application of the optional one or more toppings. Generally the spacing between the bottom surface 105 of teeth 97 and the top surface 107 of teeth 99 is 5-90% (and all values and ranges therebetween) of the spacing between the bottom surface 111 of lid member or second plate 98 and the top surface 113 of the receptacle member or first plate 96. In one non-limiting configuration, the spacing between the bottom surface 105 of teeth 97 and the top surface 107 of teeth 99 of the teeth that located at or nearest to the outer perimeter of the lid member or second plate 98 and the receptacle member or first plate 96 is 5-20% (and all values and ranges therebetween) of the spacing between the bottom surface 111 of lid member or second plate 98 and the top surface 113 of the receptacle member or first plate 96, and the spacing between the bottom surface 105 of teeth 97 and the top surface 107 of teeth 99 of the teeth that are located at or near the center of the lid member or second plate 98 and the receptacle member or first plate 96 is 20%-80% (and all values and ranges therebetween) of the spacing between the bottom surface 111 of lid member or second plate 98 and the top surface 113 of the receptacle member or first plate 96, and the spacing between the teeth of the bottom surface 105 of teeth 97 and the top surface 107 of teeth 99 that are located at or near the center of the lid member or second plate 98 and the receptacle member or first plate 96 is greater (e.g., 5-200% and all values and ranges therebetween) than the spacing between the bottom surface 111 of lid member or second plate 98 and the top surface 113 of the receptacle member or first plate 96, and the spacing between the teeth of the bottom surface 105 of teeth 97 and the top surface 107 of teeth 99 are located at or near the perimeter of the lid member or second plate 98 and the receptacle member or first plate 96. In another non-limiting embodiment, 10-80% (and all values or ranges therebetween) of teeth 97 and 99 are used to form the filling pocket 103, and which teeth that are used to form the filling pocket 103 are the teeth wherein the spacing between the bottom surface 105 of teeth 97 and the top surface 107 of teeth 99 of the teeth 20-90% (and all values and ranges therebetween) of the spacing between the bottom surface 111 of lid member or second plate 98 and the top surface 113 of the receptacle member or first plate 96. In another non-limiting configuration, the volume of one or more or all of the teeth 97 and 99 are used to form the filling pocket 103 is less (5-60% and all values and ranges therebetween) than a) the volume of the teeth that are located at or near the perimeter of the lid member or second plate 98 and the receptacle member or first plate 96, and/or b) the volume of the teeth that are located adjacent to the teeth that are located at or near the perimeter of the lid member or second plate 98 and the receptacle member or first plate 96.

It will be appreciated that one or more of the bi-molded plate assemblies 94 can optionally include an imprinting surface (as shown by example a waffle grid surface) for imparting all or only a portion of a surface of the multi-layered food product 10″ with a decorative design. For example, one or more surfaces defining the cavity 100 of the bi-molded plate assembly 94 can include at least one depressed and/or raised imprinting surface having a decorative or aesthetically pleasing design.

The method can begin by heating the baking plates 60 to a predetermined temperature (e.g., about 180-450° F.). Either prior to, contemporaneous with, or subsequent to Step 36, the raw components of the multi-layered food product 10″ are prepared. For example, the dough 18 can be formed by scaling (e.g., measuring out) the needed ingredients, which may include flour (e.g., about 27% to about 68% of the total batch weight), water (e.g., about 21% to about 57% of the total batch weight), milk powder (e.g., about 0% to about 28% of the total batch weight), eggs (e.g., about 2% to about 40% of the total batch weight), gluten (e.g., about 2% to about 5% of the total batch weight), sugar (e.g., about 2% to about 35% of the total batch weight), oil (e.g., about 0% to 20% of the total batch weight), leavening agent [yeast and/or chemical leavening agent] (e.g., about 1% to about 5% of the total batch weight), and salt (e.g., about 0.5% to about 2% of the total batch weight). As can be appreciated, the dough can have other formulations.

It will be appreciated that other ingredients may be added to adjust the flavor or improve the functionality of the dough 18. Examples of ingredients that can be added to adjust the flavor of the dough 18 can include butter, cheese, meats, spices, natural flavorings, and fruit or nut inclusions. Examples of ingredients that may be added to improve the functionality of the dough 18 can include protein powders for nutrition, baking enzymes, mono and diglycerides, fats, and oils. After the ingredients are scaled, the ingredients are then mixed and kneaded together for a period of time sufficient to develop the gluten structure of the dough if the dough is gluten containing 18. The fully developed dough 18 is then ready for subsequent use.

After preparing the dough 18, a measured amount of one or more fillings 16 is “encrusted” inside a measured amount of the dough to form the multi-layered food product 10″. The measured amount of filling 16 may range from about 15 grams to about 112 grams, and the measured amount of the dough 18 may range from 12 grams to about 128 grams. After the filling 16 is encrusted inside the dough 18, the formed product generally comprises a ball-shaped multi-layered food product 10″ that is substantially or completely enveloped or encapsulated by the dough and includes the filling at its center. Generally, the dough and filling are co-extruded through any industrial process. As such, a separate top and bottom layer of dough are not used wherein the filling is placed on a top layer of the bottom layer of dough and thereafter the top layer of dough is overlaid the filling and bottom layer of dough and then the edges of the top and bottom layer of dough are crimped together around 70-100% of the perimeter of the top and bottom dough layers to encapsulate the filling between the top and bottom dough layers. The present disclosure typically uses a single layer of dough to partially or fully encapsulate the filling by use of a co-extrusion process, and less than 20% (0-19.99% and all values and ranges therebetween) of the perimeter of the co-extruded dough includes a crimped region. Such co-extruded dough and filling food product in accordance with the present disclosure results in a superior baked product as to a) appearance of the multi-layered food product, b) the reduction of filling leaking from the dough layer prior to and/or during the baking of the multi-layered food product, c) the near (80-99.99% and all values and ranges therebetween) or full encapsulation of the filling in the dough layer prior to the baking of any portion of the dough layer, and/or d) includes a seamless or borderless outer perimeter (e.g., no crimped edge region). It should be appreciated that any industrial filling process, such as a sheeting of the dough 18, topping with filling 16, and then folding over a top layer of sheeted dough 18, before crimping and cutting the individual multi-layered dough product can also be used to create the multi layered dough product 10″.

The multi-layered food product 10″ can optionally be passed through a molding or shaping device (not shown) so that upper and/or lower portions of the insert or multi-layered food product are partially flattened. The molded multi-layered food product 10″ is optionally placed into a bakery proofing chamber 118 (FIG. 2A) for a period of time sufficient to adequately “rise” or “proof” the insert prior to baking. If multi-layered food product 10″ includes a chemically-leavened dough, then the proofing chamber may not be used. For example, the proofing time can vary depending upon the type and size of the dough 18 and the filling 16. Generally, the proofing time is at least five minutes and typically about 10-60 minutes; however, longer proofing times can be used.

As discussed above, multi-layered food product 10″ can either be formed in an automated assembly line 50 or automated assembly line 52 or 200.

If the multi-layered food product 10″ is formed by automated assembly line 50, one or more toppings can optionally be deposited on the outer surface of multi-layered food product 10″ by optional topping depositor(s) 91 (FIGS. 2 and 2A) to form a topping layer 13 as illustrated in FIG. 1C. As can be appreciated, one or more topping layers 13 or dough ingredient inclusions 15 can be applied to multi-layered food product 10″ as illustrated in FIG. 1D. As illustrated in FIGS. 2 and 2A, the one or more toppings are applied to the outer surface of the dough layer after the dough layer has been proofed in proofing chamber 118 and prior to the dough being partially or fully baked in oven 80. The one or more toppings that are dispensed from the optional topping depositor(s) 91 result in 1-100% (and all values and ranges therebetween), typically 10-100%, and more typically 50-100% of the top surface of the dough layer 18 being covered by the one or more toppings 13. Generally, 0-50% (and all values and ranges therebetween) of the one or more toppings that are applied to the dough layer become partially or fully embedded in the dough layer prior to the baking of the dough layer.

If the multi-layered food product 10″ is formed by automated assembly line 52, one or more toppings can optionally be deposited on the outer surface of multi-layered food product 10″ by optional topping depositor(s) 91 (FIGS. 2 and 2A) to form a topping layer 13 as illustrated in FIG. 1C. As can be appreciated, one or more topping layers 13 can be applied to multi-layered food product 10″ as illustrated in FIG. 1D. As illustrated in FIGS. 2 and 2A, the one or more toppings are applied to the outer surface of the dough layer prior to the dough layer being partially or fully baked in the oven. As can be appreciated, one of automated assembly line 50 or automated assembly line 52 can be eliminated.

Referring again to FIGS. 2 and 2A, the baking plates 60 move through an oven 80 (e.g., a tunnel oven) for a time and at a temperature sufficient to partially or fully bake the multi-layered food product 10″. The term “partially baked” means that the multi-layered food product 10″ is baked to at least about 10% of being fully baked, and typically 40-85% of being fully baked. The term “substantially baked” means that the multi-layered food product 10″ is baked to at least about 80% of being fully baked, and typically 80-99.9% of being fully baked. Fully baked means the multi-layered food product 10″ is completely baked (100% baked).

In one non-limiting arrangement, the baking plates 60 can move through oven 80 so that the multi-layered food product 10″ is partially or fully baked (i.e., 100% baked). For instance, the first baking plates 60 can move through oven 80 for a time of about 20-2000 seconds, typically 25-1000 second, and more typically 45-360 seconds and at a temperature of about 250-450° F. to partially or fully bake the multi-layered food product 10″.

As the baking plates 92 continue to advance further along the assembly line 52, the optional topping depositor(s) 91 can then be activated to optionally deposit one or more toppings 13 (e.g., 1-4 toppings) onto or atop the multi-layered food product 10″ such that 1-100% (and all values and ranges therebetween), typically 10-100%, and more typically 50-100% of the top surface of the multi-layered food product 10″ that is exposed in cavity 110 is covered by the one or more toppings 13. Generally, about 5-100% (and all values and ranges therebetween) of the one or more toppings that are applied to the top, sides or bottom of the multi-layered food product 10″ become partially or fully embedded in the dough layer prior to the baking of the dough layer, and typically about 20-100% of the one or more toppings that are applied to the dough layer become partially or fully embedded in the dough layer.

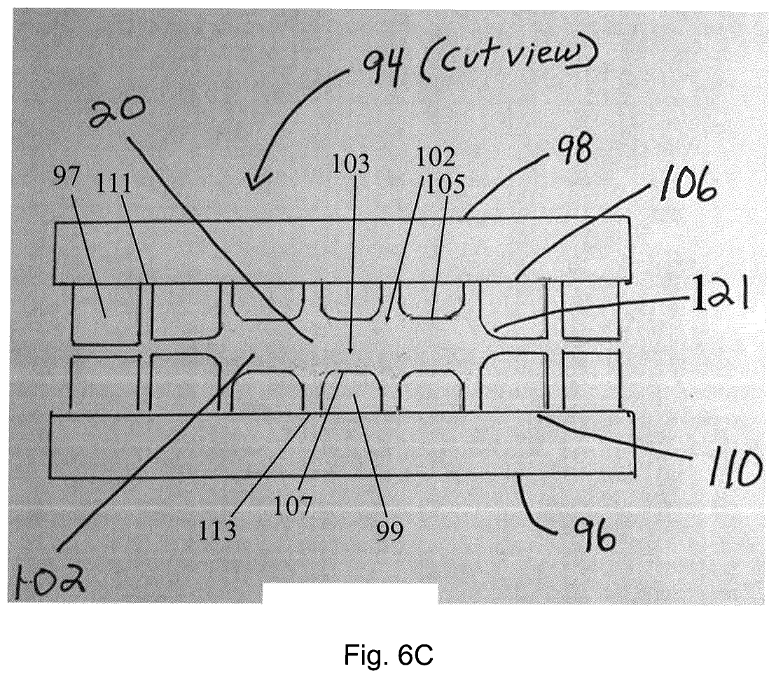

Each of the second bi-molded plate assemblies 94 is arranged to form the molded baking cavity 102. For example, the second major surface 106 of each of the lid members 98 is securely mated with the first major surface 110 of each of the receptacle members 96 to form a heated and sealed molded baking cavity 102. By “sealed” it is understood that the baking cavity 102 can include holes, gaps, vents, or other apertures that permit the release of steam, CO2, and other gasses from the baking cavity while preventing leakage of product components. The baking time for Step 46 can occur in one or more baking periods. If the baking time for Step 46 is a single baking period, the dough layer is baked until it is substantially or fully baked. If the baking time occurs in two baking periods, in the first period of time of baking, the dough layer is baked 5-60% of the time of fully baking the dough layer, and typically 5-49 of the time of fully baking the dough layer. After baking for the first period of time, the second baking plates 92 can be optionally rotated about the rotation members 82 (indicated by arrows) so that the second bi-molded plate assemblies 94 is inverted (FIG. 7). Inverting the second bi-molded plate assemblies 94 facilitates in more even baking throughout the multi-layered food product. After optionally inverting the second baking plates 92, the second baking plates are heated for a second period of time. The second period of time can be about 40% to about 95% of the total time needed to bake the multi-layered food product, and typically 51-95% of the time needed to fully bake the dough layer. The second period of time can optionally be the same or greater than the first period of time. It should be understood that if the baking plates 92 are not inverted, then the entire baking process (first and second periods of time) is combined into one baking period. By baking components (e.g., all of the components) of the multi-layered food product under pressure and at a uniform temperature, the dough layer 18 and the optional topping(s) 13, the filling 16 can be combined to form a substantially seamless, borderless product (e.g., little or no crimped region). It should be appreciated that there can optionally be a 3^{rd} or even 4^{th} baking period in addition to a first and second baking period which can further increase the baking quality and functionality of the baking process.

The automatic removing system 84 separates the lid member 98 and the receptacle member 96 of each of the second bi-molded plate assemblies 94 after the multi-layered food product has been sufficiently baked. Since each of the receptacle members 96 is inverted, separation of the lid members 98 from the receptacle members allows the multi-layered food product to be easily removed from the second bi-molded plate assemblies 94 via gravity since the larger volume cavity is on top. Alternatively, the multi-layer food product can be removed by a suction mechanism or needles (not shown) once the bi-molded plate assemblies 94 are opened. For example, if the receptacle members 96 are not inverted during the baking process, suction or needles can be used to remove the multi-layer food product from the opened bi-molded plate assemblies 94; however, other removal processes can be used.

After removing the multi-layered food product from the bi-molded plate assemblies 94, the multi-layered food product is cooled for an appropriate period of time before freezing, wrapping, and packaging. The packaged multi-layered food product can be boxed and further frozen ahead of distribution to the marketplace.

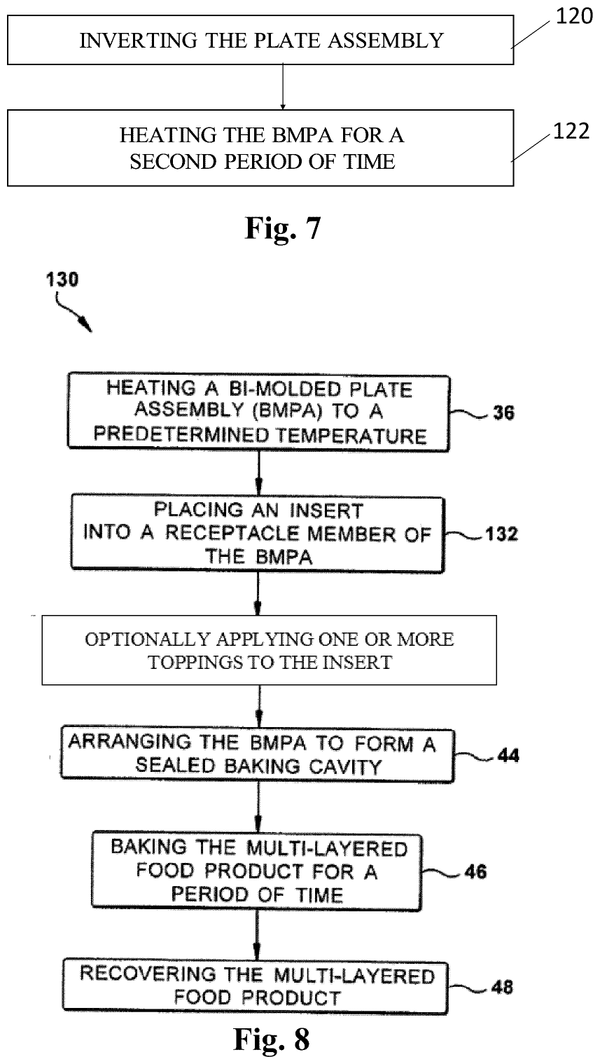

As illustrated in FIG. 8, another aspect of the present disclosure includes a method 130 for forming a multi-layered food product 10″. As discussed above, multi-layered food product 10″ can be formed an automated assembly line 50 or in automated assembly line 52, depending on the type of dough layer used to form multi-layered food product 10″. For example, the method 130 can be performed using an automated assembly line that is identical or similar to the automated assembly line 50 described above. Additionally, the method 130 can be performed using bi-molded plate assemblies (not shown) that are similar to the bi-molded plate assemblies described above or bi-molded plate assemblies 94 as described above.

Method 130 can begin by heating the bi-molded plate assemblies to a predetermined temperature (e.g., about 300-450° F.). Either prior to, contemporaneous with, or subsequent to Step 36, the raw components of the multi-layered food product 10″ can be prepared. For example, the dough 18 can be formed by scaling (e.g., measuring out) the needed ingredients (as described above). As also described above, it will be appreciated that other ingredients, such as inclusion ingredients 15, may be added to adjust the flavor or improve the functionality of the dough 18. Additionally, the filling layer 16 and the optional topping(s) layer 13 ingredients are prepared.

After the ingredients are scaled, the ingredients can be mixed and kneaded together for a period of time. When the dough 18 is a yeast-leavened dough, the ingredients are mixed and kneaded together for a period of time sufficient to develop the gluten structure of the yeast leavened dough 18. Next, a measured amount of one or more fillings 16 can be “encrusted” inside a measured amount of the dough 18 using a known bakery machining process, such as co-extrusion or sheeting and crimping. In one non-limiting embodiment, the measured amount of filling 16 can be about 15-99 grams, and the measured amount of the dough 18 can be about 12-128 grams. After the filling 16 is encrusted inside the dough 18, the formed product comprises a ball-shaped insert 12″ that is substantially or completely enveloped or encapsulated by the dough and includes the filling at its center.

The insert 12″ can optionally be passed through a molding or shaping device (not shown) so that upper and lower portions of the insert are partially flattened. The molded insert 12′″ is then optionally placed into a bakery proofing chamber 118 for a period of time sufficient to adequately “rise” or “proof” the insert prior to baking. For example, the proofing time can vary from about 10-60 minutes, depending upon the type and size of the dough 18 and the filling 16. After the insert 12″ is adequately proofed, it is ready for subsequent use.

Upon heating each of the bi-molded plate assemblies to the predetermined temperature and forming the raw components of the multi-layered food product 10″, the insert 12″ can be placed into a receptacle member of a bi-molded plate assembly (Step 132). At Step 43, optionally one or more toppings 13 can be sprinkled or poured atop the insert 12″ before the lid member is mated with the receptacle member to form a sealed baking cavity (Step 44). The one or more optional toppings 13 typically cover about 50-100% of the top half of insert 12″ prior to closing the lid member and baking and forming the food product 10″ as illustrated in FIGS. 1A-1D.

Following formation of the sealed baking cavity, the insert 12″ can be partially or fully baked at Step 46. As described above, an insert 12″ is taken from the proofing chamber 118 and deposited into the receptacle member of a bi-molded plate assembly. It will be appreciated that the insert 12″ can be deposited into the receptacle member by any one or combination of mechanisms known in the art, such as via a robotic arm, conveyor belt system 140 (FIG. 3), or by hand. Once the insert 12″ is deposited into the receptacle member and the optional topping(s) 13 are deposited below or atop insert 12″, the receptacle members and the lid members move about the tracts of an oven 80 (e.g., a tunnel oven) to securely mate with another and thereby form a plurality of bi-molded plate assemblies.

The bi-molded plate assemblies then move through the oven 80 for a time and at a temperature sufficient to partially or fully bake the insert 12″ and the optional topping(s) 13. For example, the bi-molded plate assemblies can move through oven 80 so that the insert 12″ and the topping(s) are baked to completion (100% baked). For instance, the first bi-molded plate assemblies can move through the oven 80 for a time of about 1-4 minutes and at a temperature of about 300-450° F. to completely bake the insert 12″ and the optional topping(s) 13.

After the bi-molded plate assemblies pass through the oven 80, the receptacle members and the lid members are separated as shown in FIG. 2 so that the multi-layered food product 10″ can be removed from the plates and cooled for an appropriate period of time before freezing, wrapping, and packaging. The packaged multi-layered food product 10″ can be boxed and further frozen ahead of distribution to the marketplace.

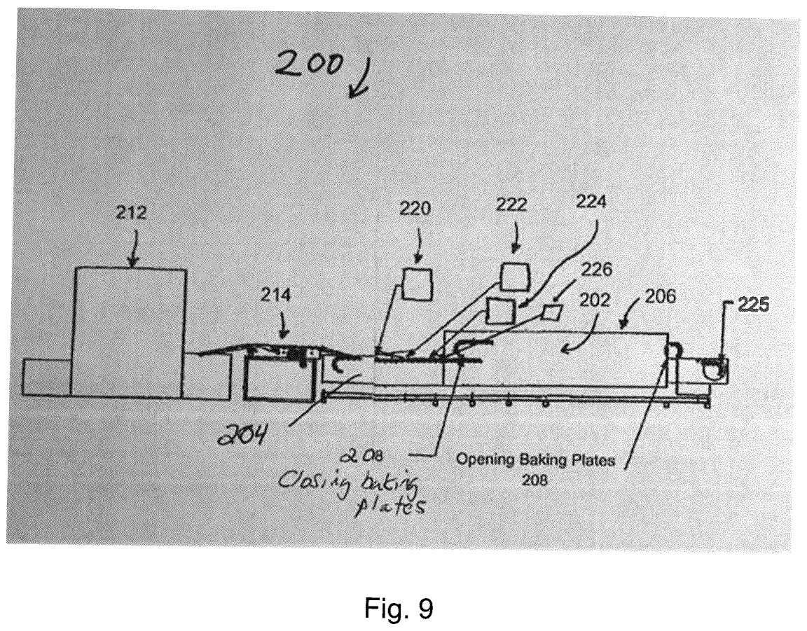

It will be appreciated that the present disclosure can include an alternative assembly line system 200 (FIG. 9) for forming a multi-layered food product. As illustrated in FIG. 9, the assembly line system 200 includes a series of upper and lower loop-shaped tracts 202 and 204, a portion of each of which is disposed within an oven 206. The upper and lower tracts 202 and 204 include a plurality of baking plates 208 (not shown in detail) securely mounted thereto that can be mated together to form a plurality of bi-molded plate assemblies (not shown) (as described above). The lower tract 204 has a greater length than the upper tract 202, which allows the components of the multi-layered food product 10 to be supplied to the baking plates 208 as shown in FIG. 9. Other components of the assembly line system 200 are similar or identical to those shown in FIG. 3 and described above, such as an optional bakery proofing chamber 212, a conveyor belt system 214, an oven 206, a transfer machine 214, an insert feeding system 222, an optional topping device 226, and an optional automatic removing system 225. For example, the oven 206 is different from the oven 80 described above because there is no inversion or flipping of plates during operation.

In operation, the baking plates are heated to a pre-determined temperature (as described above). The baking plates 208 are then advanced along the lower tract 204 (e.g., clockwise) to the insert feeding system 222, which is activated to place a substantially baked insert in each of the baking plates 208. As the baking plates 208 continue to advance along the lower tract 204, and the optional topping device 226 is then activated to sprinkle one or more toppings 13 below or atop the insert. Once the optional one or more toppings layers 13 are deposited in the insert, the baking plates of the upper tract 202 rotate (e.g., counter-clockwise) to securely mate with the baking plates of the lower tract 204, thereby forming the plurality of bi-molded plate assemblies. When one or more toppings are applied to the surfaces of the insert, about 5-100% of the toppings are partially or fully embedded in the dough layer prior to the full baking of the dough layer.

Next, the bi-molded plate assemblies move through the oven 206 for a time and at a temperature sufficient to substantially or completely bake the multi-layered food product (as described above). The total bake time is about 30-360 seconds. After the bi-molded plate assemblies pass through the oven 206, the baking plates of the lower and upper tracts 204 and 202 are separated so that the partially or fully baked multi-layered food product is removed from each of the bi-molded plate assemblies (e.g., by gravity or an automatic removing system 225) and cooled for an appropriate period of time before freezing, wrapping, and packaging. The packaged multi-layered food product can be boxed and further frozen ahead of distribution to the marketplace.

Consumers of the multi-layered food products 10″ can reheat or prepare the frozen product by microwave, oven, toaster, air fryer, or by a combination of a microwave and a toaster or toaster oven. The frozen multi-layered food product can be heated by a microwave for a period of time (e.g., 10-80 seconds (depending on microwave strength)) and then optionally toasted or air fried for a period of (20-250 seconds on a low-medium setting).

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

What is claimed:

1. A method for forming a plurality of filled food products on an automated assembly line system; said method comprising the steps of:
a) providing an automated assembly line; said automated assembly line including I) a plurality of plate assemblies, II) a drive arrangement to cause said plurality of plate assemblies to continuously move through various regions of said automated assembly line, III) an automated food insert feeder arrangement, IV) an automated mating arrangement, V) an optional preheat heating system, and VI) an oven system; each of said plate assemblies includes a first plate and a second plate; said first plate is configured to at least partially receive a food insert; said second plate is configured to be inserted over said first plate to form a closed cavity that at least partially encapsulates said food insert when said food insert is positioned in said closed cavity; said food insert includes a filling and a dough layer; said dough layer encapsulates at least 80% of said filling; said food insert is at least partially formed of a coextrusion process or sheeted and filled crimping process wherein said filling and said dough layer are coextruded or crimped; a composition of said filling and dough layer is different;
b. causing said automated food insert feeder arrangement to place said food insert onto said first plate of each of said plate assemblies;
c. causing said automating mating arrangement to mate said second plate with said first plate to form a closed cavity for each of said plate assemblies while said plate assemblies are moved through said automated assembly line assembly so that said food insert in each of said plate assemblies is at least partially encapsulated in said closed cavity;
d. moving said plurality of said plate assemblies by said drive arrangement into said oven system while said food insert in each of said plate assemblies is at least partially encapsulated in said closed cavity;
e. baking said food insert in each of said plate assemblies for a period of time as said plate assemblies are moved by said drive arrangement through said oven system to form a baked food insert;
f. moving said plurality of plate assemblies by said drive arrangement so as to cause said plurality of plate assemblies to be removed from said oven system after said period of time; and
g. causing said baked food insert in each of said cavities of said plate assemblies to be automatically removed from said plate assembly.

2. The method as defined in claim 1, wherein said first plate includes a) a plurality of spaced apart teeth extending upwardly from a top surface of said first plate, and wherein a plurality of said teeth have a different upwardly extending height from said top surface and/or b) said second plate includes a plurality of spaced apart teeth extending downwardly from a bottom surface of said second plate, and wherein a plurality of said teeth have a different downwardly extending height from said bottom surface.

3. The method as defined in claim 2, wherein said first plate and said second plate forms a waffle-shaped baked food insert.

4. The method as defined in claim 2, wherein said plurality of said teeth on said first plate and said plurality of said teeth on said second plate are spaced apart from one another when said second plate and said first plate are mated together to form said closed cavity.

5. The method as defined in claim 3, wherein said plurality of said teeth on said first plate and said plurality of said teeth on said second plate are spaced apart from one another when said second plate and said first plate are mated together to form said closed cavity.

6. The method as defined in claim 2, wherein an enhanced sized food pocket is formed in said closed cavity which reduces an amount of compressive force on said food insert in said first plate includes a) a plurality of said spaced apart teeth extending upwardly from said top surface of said first plate and which are located in a central region of said first plate extend upwardly from said top surface a less amount than a plurality of said spaced apart teeth extending upwardly from said top surface of said first plate and which are located at or adjacent to an outer perimeter of said first plate, and/or b) a plurality of said spaced apart teeth extending downwardly from said bottom surface of said second plate and which are located in a central region of said second plate extend downwardly from said bottom surface a less amount than a plurality of said spaced apart teeth extending downwardly from said bottom surface of said second plate and which are located at or adjacent to an outer perimeter of said second plate.

7. The method as defined in claim 5, wherein an enhanced sized food pocket is formed in said closed cavity which reduces an amount of compressive force on said food insert in said first plate includes a) a plurality of said spaced apart teeth extending upwardly from said top surface of said first plate and which are located in a central region of said first plate extend upwardly from said top surface a less amount than a plurality of said spaced apart teeth extending upwardly from said top surface of said first plate and which are located at or adjacent to an outer perimeter of said first plate, and/or b) a plurality of said spaced apart teeth extending downwardly from said bottom surface of said second plate and which are located in a central region of said second plate extend downwardly from said bottom surface a less amount than a plurality of said spaced apart teeth extending downwardly from said bottom surface of said second plate and which are located at or adjacent to an outer perimeter of said second plate.

8. The method as defined in claim 2, wherein a) a plurality of said spaced apart teeth extending upwardly from said top surface of said first plate have a rounded bottom surface, and/or b) a plurality of said spaced apart teeth extending downwardly from said bottom surface of said second plate have a rounded top surface.

9. The method as defined in claim 7, wherein a) a plurality of said spaced apart teeth extending upwardly from said top surface of said first plate have a rounded bottom surface, and/or b) a plurality of said spaced apart teeth extending downwardly from said bottom surface of said second plate have a rounded top surface.

10. The method as defined in claim 1, wherein said automating mating arrangement causes said mated first and second plates to move away from one another to open said cavity as said plate assemblies are moved through said automated assembly line assembly.

11. The method as defined in claim 9, wherein said automating mating arrangement causes said mated first and second plates to move away from one another to open said cavity as said plate assemblies are moved through said automated assembly line assembly.

12. The method as defined in claim 1, wherein said dough layer of said food insert is a) proofed prior to being inserted on said first plate, and/or b) baked for a period before being inverted and baked for a second period.

13. The method as defined in claim 11, wherein said dough layer of said food insert is a) proofed prior to being inserted on said first plate, and/or b) baked for a period before being inverted and baked for a second period.

14. The method as defined in claim 1, further including the step of inserting one or more toppings on said food insert; said topping having a different composition from said filling and said dough layer.

15. The method as defined in claim 13, further including the step of inserting one or more toppings on said food insert; said topping having a different composition from said filling and said dough layer.
